(19) United States
(12) Patent Application Publication
(10) Pub. No.: US 2024/0411808 A1
(43) Pub. Date: Dec. 12, 2024

(54) SYSTEMS AND METHODS FOR PROVIDING VOICE ASSISTANCE IN A VEHICLE

(71) Applicant: Mercedes-Benz Group AG, Stuttgart (DE)

(72) Inventors: Sachin Gupta, Santa Clara, CA (US); Albert Zarate, San Jose, CA (US); Jagjit Pal, Tracy, CA (US); Alexander Hilliger von Thile, Santa Clara, CA (US); Christopher Tharpe, San Francisco, CA (US)

(21) Appl. No.: 18/680,765

(22) Filed: May 31, 2024

Related U.S. Application Data
(60) Provisional application No. 63/506,693, filed on Jun. 7, 2023.

(51) Int. Cl. G06F 16/683; G01C 21/36; G06F 16/687; G10L 15/183; G10L 15/22

(52) U.S. Cl. CPC G06F 16/685; G01C 21/3679; G06F 16/687; G10L 15/183; G10L 15/22; G10L 2015/223

(57) ABSTRACT

Methods, computing systems, and technology are presented for providing voice assistance in a vehicle. For example, a computing system may be configured to access a first voice prompt indicative of a speech-based voice query provided by a user of the vehicle. The computing system may be configured to determine, based on the first voice prompt, a first prompt message corresponding to a text-based transcription of the first voice prompt. The computing system may be configured to process the first prompt message with a machine-learned large language model trained to generate a digital message response based on the first prompt message. The computing system may be configured to convert the digital message response to a speech-based voice response. The computing system may be configured to provide the speech-based voice response as audio output to the user of the vehicle.

### PRIORITY CLAIM

This application claims priority to and the benefit of U.S. Provisional Patent Application No. 63/506,693 filed on Jun. 7, 2023, which is incorporated herein by reference for all purposes.

### FIELD

The present disclosure relates generally to using machine-learned models to provide voice assistance to a user, such as a driver or passenger of a vehicle. More particularly, the present disclosure relates to systems and methods for providing voice assistance technology in a vehicle with integrated generative artificial intelligence (AI) and prompt processing systems.

### BACKGROUND

Vehicles, such as automobiles, have onboard control systems that operate certain functions of a vehicle in response to input from a user of the vehicle (e.g., a driver or a passenger). Input data may include voice input provided to an input device such as a microphone or touch input provided to an input device such as a touchscreen, keypad, or other touch-activated control mechanism. In response to the input data, various outputs can be provided to the control systems or to other output devices in a vehicle (e.g., audio output provided to a microphone, graphic output provided to a display device, etc.).

### SUMMARY

Aspects and advantages of implementations of the present disclosure will be set forth in part in the following description, or may be learned from the description, or may be learned through practice of the implementations.

One example aspect of the present disclosure is directed to a computing system of a vehicle. The computing system includes one or more processors and one or more tangible, non-transitory, computer readable media storing instructions that when executed by the one or more processors cause the computing system to perform operations. The operations include accessing a first voice prompt indicative of a speech-based voice query provided by a user of the vehicle. The operations include determining, based on the first voice prompt, a first prompt message corresponding to a text-based transcription of the first voice prompt. The operations include processing the first prompt message with a machine-learned large language model trained to generate a digital message response based on the first prompt message. The operations include converting the digital message response to a speech-based voice response. The operations include providing the speech-based voice response as audio output to the user of the vehicle.

In an embodiment, the operations include converting the digital message response to a graphical response and providing the graphical response as visual output to the user of the vehicle in conjunction with providing the speech-based voice response as audio output to the user of the vehicle.

In an embodiment, the speech-based voice query provided by a user of the vehicle includes a request for information associated with a point of interest category in a particular geographic area. The speech-based voice response is indicative of a plurality of particular points of interest determined by the machine-learned large language model to be associated with the point of interest category and the particular geographic area.

In an embodiment, the operations include receiving user selection data indicative of a selected point of interest from the plurality of particular points of interest and generating vehicle navigation data as an output to the user of the vehicle, the vehicle navigation data indicative of navigational directions to the selected point of interest.

In an embodiment, the operations include comparing a first address associated with the selected point of interest as determined by the machine-learned large language model with a second address associated with the selected point of interest determined from a vehicle navigation database to determine a more recently updated address associated with the selected point of interest. The operations also include providing vehicle navigation data associated with the more recently updated address associated with the selected point of interest as the output to the user of the vehicle.

In an embodiment, the operations include determining a type of the first prompt message as one of a first type for processing by a vehicle system onboard the vehicle or a second type for processing by the machine-learned large language model. The operations also include processing the first prompt message with the machine-learned large language model in response to determining the first prompt message to be the second type for processing by the machine-learned large language model.

In an embodiment, the operations include performing a validation function to the digital message response before providing the speech-based voice response as audio output to the user of the vehicle.

In an embodiment, determining the first prompt message corresponding to a text-based transcription of the first voice prompt is implemented by a prompt processing system having been trained using terminology from a user guide specific to the vehicle.

In an embodiment, the first prompt message corresponds to one or more of a full transcription, a partial transcription, or a modified transcription of the first voice prompt.

In an embodiment, the machine-learned large language model includes a generative pre-trained transformer model.

Another example aspect of the present disclosure is directed to a computer-implemented method. The method includes accessing a first voice prompt indicative of a speech-based voice query provided by a user of a vehicle. The method also includes determining, based on the first voice prompt, a first prompt message corresponding to a text-based transcription of the first voice prompt. The method also includes processing the first prompt message with a machine-learned large language model trained to generate a digital message response based on the first prompt message. The method also includes converting the digital message response to a speech-based voice response. The method also includes providing the speech-based voice response as audio output to the user of the vehicle.

In an embodiment, the method also includes converting the digital message response to a graphical response and providing the graphical response as visual output to the user of the vehicle in conjunction with providing the speech-based voice response as audio output to the user of the vehicle.

In an embodiment, the speech-based voice query provided by a user of the vehicle includes a request for information associated with a point of interest category in a particular geographic area. In addition, the speech-based voice response is indicative of a plurality of particular points of interest determined by the machine-learned large language model to be associated with the point of interest category and the particular geographic area.

In an embodiment, the method also includes receiving user selection data indicative of a selected point of interest from the plurality of particular points of interest. The method also includes generating vehicle navigation data as an output to the user of the vehicle, the vehicle navigation data indicative of navigational directions to the selected point of interest.

In an embodiment, the method also includes comparing a first address associated with the selected point of interest as determined by the machine-learned large language model with a second address associated with the selected point of interest determined from a vehicle navigation database to determine a more recently updated address associated with the selected point of interest. The method also includes providing vehicle navigation data associated with the more recently updated address associated with the selected point of interest as the output to the user of the vehicle.

In an embodiment, the method also includes determining a type of the first prompt message as one of a first type for processing by a vehicle system onboard the vehicle or a second type for processing by the machine-learned large language model. The method also includes processing the first prompt message with the machine-learned large language model in response to determining the first prompt message to be the second type for processing by the machine-learned large language model.

In an embodiment, the method also includes performing a validation function to the digital message response before providing the speech-based voice response as audio output to the user of the vehicle.

In an embodiment, determining the first prompt message corresponding to a text-based transcription of the first voice prompt is implemented by a prompt processing system having been trained using terminology from a user guide specific to the vehicle.

Yet another example aspect of the present disclosure is directed to one or more tangible, non-transitory, computer readable media storing instructions for execution by one or more processors to cause the one or more processors to perform operations. The operations include accessing a first voice prompt indicative of a speech-based voice query provided by a user of a vehicle. The operations also include determining, based on the first voice prompt, a first prompt message corresponding to a text-based transcription of the first voice prompt. The operations also include processing the first prompt message with a machine-learned large language model trained to generate a digital message response based on the first prompt message. The operations also include converting the digital message response to a speech-based voice response. The operations also include providing the speech-based voice response as audio output to the user of the vehicle.

In an embodiment, the operations also include performing a validation function to the digital message response before providing the speech-based voice response as audio output to the user of the vehicle.

Other example aspects of the present disclosure are directed to other systems, methods, vehicles, apparatuses, tangible non-transitory computer-readable media, and devices for the technology described herein.

These and other features, aspects, and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of implementations directed to one of ordinary skill in the art are set forth in the specification, which makes reference to the appended figures, in which:

FIG. 1 illustrates an example computing ecosystem according to an embodiment hereof.

FIG. 2 illustrates an example system for providing voice assistance in a vehicle according to an embodiment hereof.

FIG. 3A illustrates an example dataflow for an example user prompt processing system for providing voice assistance in a vehicle according to an embodiment hereof.

FIG. 3B illustrates an example dataflow for an example generative AI system for providing voice assistance in a vehicle according to an embodiment hereof.

FIG. 4 illustrates an example vehicle interior with example interface devices according to an embodiment hereof.

FIGS. 5-10 illustrate example user interfaces in accordance with a first example of providing voice assistance in a vehicle according to an embodiment hereof.

FIGS. 11-17 illustrate example user interfaces in accordance with a second example of providing voice assistance in a vehicle according to an embodiment hereof.

FIGS. 18-19 illustrate respective flowchart diagrams of example methods according to an embodiment hereof.

FIG. 20 illustrates a diagram of an example computing ecosystem with computing components according to an embodiment hereof.

### DETAILED DESCRIPTION

Aspects of the present disclosure relate to methods, systems, and computer program products for providing voice assistance to a user, such as a driver or passenger of a vehicle. More specifically, the present disclosure relates to integrating a voice assistance system of a vehicle with a generative artificial intelligence (AI) system, and more specifically with a large language model (LLM) system.

In some embodiments, the voice assistance system may be located in the vehicle, and may communicate with a user prompt processing system located remote from the vehicle. For instance, the user prompt processing system may be a cloud-based platform that communicates with the voice assistance system via a network, and may process voice prompts received by the voice assistance system (and may process other user prompts). The voice assistance system or user prompt processing system may perform a validation function, to validate a response or other output from the generative AI system.

In an example embodiment, the voice assistance system may receive or otherwise access a first voice prompt (e.g., a speech-based voice query) from a user of the vehicle. The voice assistance system may include, for example, one or more microphones or other sound sensors configured to capture or otherwise sense the first voice prompt (e.g., “Hey Mercedes, suggest a national park to drive to from Sunnyvale”). The voice assistance system may be, for example, part of an automotive head unit/infotainment system. In some implementations, the voice assistance system may include one or more processors that are configured to perform a transcription, speech recognition, or speech-to-text function. In some implementations, the transcription, speech recognition, or speech-to-text function may be performed on the user prompt processing system (e.g., based on audio data captured by the one or more microphones). As mentioned above, the user prompt processing system may be, for example, a cloud-based platform that supports the voice assistance system with additional processing power/capabilities.

The voice assistance system may be configured to determine, based on the first voice prompt, a first prompt message corresponding to a text-based transcription of the first voice prompt. The transcription, speech recognition, or speech-to-text function of the voice assistance system may generate a first prompt message that is, for example, a full transcription of the first voice prompt, or a partial transcription (e.g., “suggest a national park to drive to from Sunnyvale”) or modified transcription of the first voice prompt. If the transcription or voice recognition function is performed by the voice assistance system on the vehicle, then the user prompt processing system may be omitted, or may receive the first prompt message from the voice assistance system and may determine whether the first prompt message needs to be modified (e.g., to add context information).

In an embodiment, the user prompt processing system or the voice assistance system may communicate the first prompt message (e.g., “suggest a national park to drive to from Sunnyvale”) to the generative AI system, which may process the first prompt message with a generative AI model to generate a response based on the first prompt message. In some instances, the generative AI system may be a LLM system, and the generative AI model may be a LLM model. Accordingly, the LLM system generates a response (referred to herein as an AI system response or digital message response) based on the first prompt message.

The user prompt processing system or voice assistance system may receive the AI system response (e.g., a digital message), and generate a voice response for the user. The voice response may be generated via a speech synthesis function that, for example, converts the AI system response to a voice response. In some instances, the speech synthesis function may generate an audio file or audio stream, and may be performed on the user prompt processing system or the voice assistance system. In some instances, the voice assistance system may include one or more speakers configured to play the audio file or audio stream.

Additionally or alternatively, the user prompt processing system or the voice assistance system may receive the AI system response (e.g., a digital message), and generate a graphical response for the user. The graphical response may be generated via an image processing function that, for example, converts the AI system response to a graphical response. In some instances, the image processing function may generate an image or video file, and may be performed on the user prompt processing system or the voice assistance system. In some instances, the voice assistance system may include one or more touchscreens or other display devices to provide the graphical response as visual output to the user of the vehicle.

In an embodiment, the user prompt processing system or the voice assistance system may not communicate the first prompt message to the generative AI system. For example, if the user of the vehicle wants to control the vehicle environmental setting, there is no need to communicate with the generative AI system.

As mentioned above, one aspect of the disclosure further relates to validating the AI system response, before sharing the AI system response with the user or before generating the voice response based on the AI system response. In an example, the validation may involve generating a graphical response (or other visual response) based on the AI system response, and displaying the graphical response through a screen or other user interface of the head unit of the vehicle. In another example, the response is displayed in the head unit and also read out aloud by the voice assistance system.

In an example, a user provides a voice prompt to the voice assistance system, by saying “Hey Mercedes, suggest a national park to drive to from Sunnyvale”. The voice assistance system or user prompt processing system may generate a prompt message (e.g., a digital message) that is based on the voice prompt, and communicate the prompt message to generative AI system. The generative AI system may generate an AI system response that identifies some of the most famous or visited national parks around Sunnyvale (e.g., “Yosemite National Park is a great choice for a drive from Sunnyvale. It's about a three-hour drive, and you'll get to see some of the most stunning scenery in the United States.”). The generative AI system may send the AI system response to the user prompt processing system or voice assistance system. The voice assistance system may outputs a voice response that reads out aloud. This may a response such as, for example: “Yosemite National Park is a great choice for a drive from Sunnyvale. It's about a three-hour drive, and you'll get to see some of the most stunning scenery in the United States.”

In some instances, the voice response may be a modified version of the AI system response. In some instances, the voice response may be an exact text-to-speech replication of the AI system response.

In an example embodiment, the head unit of the vehicle may display Yosemite National Park as Point of Interest in the head unit of the vehicle. The vehicle may start route guidance to Yosemite National Park if the user taps (or otherwise selects) on Yosemite National Park.

In an implementation, the user prompt processing system validates the AI system response, real addresses in real time. So if “Hey Mercedes” shows Yosemite National Park as Point of Interest on the head unit, the prompt processing system compares the address response generated by the generative AI system and compares it with the address of Yosemite National Park as present in the vehicle navigation data. This comparison ensures that the address is up-to-date and the user is provided with the up-to-date route guidance. In the event that the address response generated by the generative AI system is not up-to-date, the user prompt processing system may override the vehicle navigation data on the address response generated by the generative AI model.

In an implementation, the LLM system may scan the Internet to formulate complex answers from billions of words.

In an implementation, the integration of the voice assistance system of a vehicle with the generative artificial intelligence (AI) system may allow the user of the vehicle to have his/her queries answered, receive sports and weather updates, control vehicle environmental settings, interact with their smart homes, etc. Other examples may include restaurant recommendations, writing short internal stories, or details about landmarks. Further, the user may experience more adaptive responses when searching for points of interest, such as when searching for restaurants or gas stations.

The technology of the present disclosure provides a number of technical effects and improvements to vehicle and computing technology. For instance, a voice assistance system for a vehicle may leverage one or more machine-learned models to generate adaptive responses that are appropriately tailored to effectively answer a user's queries. One example machine-learned model for use with a voice assistance system is a machine-learned large language model (LLM), such as provided as part of a generative AI system. Because LLMs may be pre-trained on a substantially large corpus of data, they are advantageously able to understand, generate, and manipulate text on a massive scale. LLMs are also highly scalable for vehicle use because they can be adapted in a customized fashion to various vehicle functions such as navigation.

By improving the voice assistance system in a vehicle, the technology of the present disclosure may reduce or replace manually programmed point of interest (POI) information, navigation information, car function settings, or other inputs from a user, which may cause delays in implementing user-desired vehicle tasks. In this manner, for example, the technology of the present disclosure may increase responsiveness of the vehicle in implementing vehicle functions (e.g., reduced latency). Furthermore, by improving the effective responsiveness of a vehicle's voice assistance system, the technology of the present disclosure may help preserve processing power and rendering capacity (e.g., capacity for rendering audio communications, graphical communications) of a vehicle's infotainment system or the like, thereby helping to preserve such resources for other vehicle operations.

Moreover, the improved voice assistance system may produce more accurate responses to user prompts. This can be realized in the context of employing a machine-learned large language model (LLM) by performing pre-processing of data provided to an LLM and post-processing of data received from the LLM. For example, user prompt messages can be adapted from speech as captured verbatim to digital messages that are more suitable as input queries. Similarly, once AI system responses are generated by an LLM, they can be further adapted for optimized audio or visual presentation to a user. For instance, audio outputs can be truncated to provide more focused information that is less potentially distracting to a vehicle user. Additionally or alternatively, AI system responses can be validated (e.g., to ensure accurate locations for navigation directions) before providing an audio or visual output to a user of the vehicle. By reducing the likelihood that a response to a user prompt will not be successful, the technology of the present disclosure can help prevent additional follow-up queries or requests, thus preserving the limited processing, memory, power, and bandwidth resources on the vehicle for more core vehicle operations.

Additional improvements to the overall effectiveness of a voice assistance system can be realized by utilizing a machine-learned user prompt processing system that has been trained using terminology from a user guide specific to the vehicle. In this way, when a user voice prompt includes queries or requests that are specific to a function of a particular type of vehicle (e.g., adjusting ambient lighting in a Mercedes-Benz), such function can be readily recognized and potentially processed by one or more vehicle systems without needing to be processed by a generative AI system. Effective prompt processing can help distinguish between first and second different types of prompt messages received from a user (e.g., a first type for processing by a vehicle system and a second type for processing by a machine-learned large language model). More effective identification of a type of prompt message (e.g., a user vehicle function request versus a request for local search) can provide a faster and more accurate response to user requests.

The automated vehicle actions generated by the systems and methods of the present disclosure may also improve the overall efficiency of the vehicle's onboard computing resources. For instance, providing an informative and accurate response to a voice assistance request from a user can reduce the number of user interactions that a user would otherwise have with a voice assistance system. By reducing the frequency of user interaction, the vehicle can reduce the amount of processing and memory resources that are spent each time a user requests to interact with the voice assistance system or otherwise manually engages a vehicle navigation or vehicle control function. Additionally, this can lead to less wear on the physical interfaces associated with the vehicle functions.

Still further, the improved voice assistance system provides vehicle users with functional enhancements not available with conventional voice assistance technology. More particularly, the integration of large language model technology within the vehicle context, provide a voice assistant model with multiple computing enhancements. These enhancements include improved conversational AI, better personalization within the vehicle, a more interactive user experience, and more efficient and effect error handling. This technology can improve an overall user experience through improved support of general knowledge, language translation, travel assistance, location-based queries, etc. As described herein, the improved user experience helps improve computational efficiency by avoiding computationally expensive processing re-work that can consume limited onboard resources such as bandwidth, memory, etc. As such, these save resources can be allocated for improved vehicle core functionalities including vehicle driving assistance, object recognition, motion control, etc. Thus, ultimately, the systems and methods of the present disclosure improve the computational efficiency and configurability of a vehicle while also providing a personalized user experience.

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations may be made to the embodiments without departing from the scope or spirit of the present disclosure. For instance, features illustrated or described as part of one embodiment may be used with another embodiment to yield a still further embodiment. Thus, it is intended that aspects of the present disclosure cover such modifications and variations.

The technology of the present disclosure may include the collection of data associated with a user in the event that the user expressly authorizes such collection. Such authorization may be provided by the user via explicit user input to a user interface in response to a prompt that expressly requests such authorization. Collected data may be anonymized, pseudonymized, encrypted, noised, securely stored, or otherwise protected. A user may opt out of such data collection at any time.

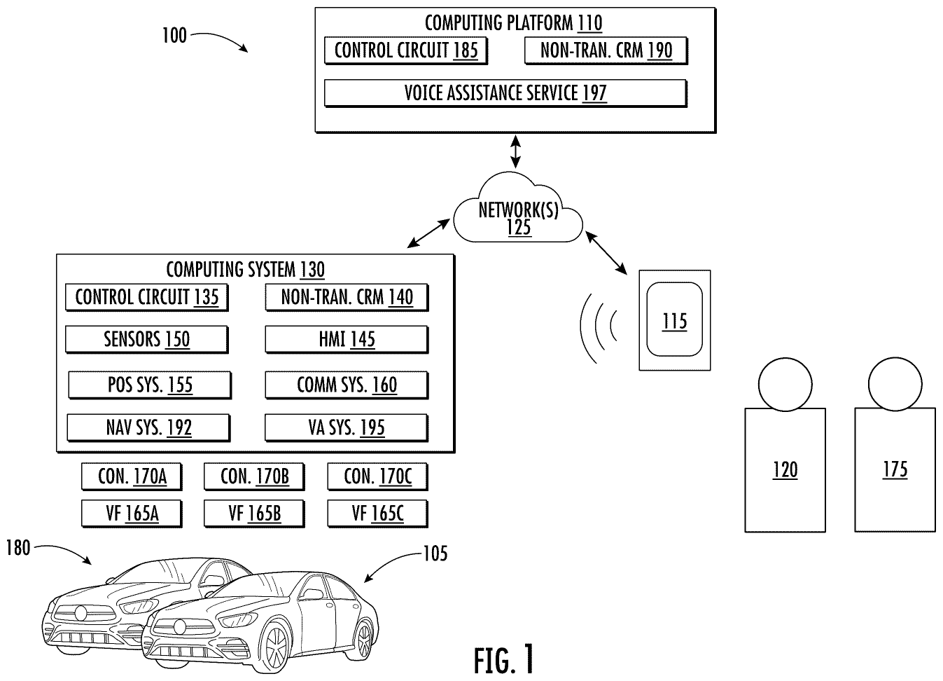

FIG. 1 illustrates an example computing ecosystem 100 according to an embodiment hereof. The ecosystem 100 may include a vehicle 105, a remote computing platform 110 (also referred to herein as cloud-based computing platform 110), and a user device 115 associated with a user 120. The user 120 may be a driver of the vehicle. In some implementations, the user 120 may be a passenger of the vehicle. The vehicle 105, the computing platform 110, and the user device 115 may be configured to communicate with one another via one or more networks 125.

The systems/devices of ecosystem 100 may communicate using one or more application programming interfaces (APIs). This may include external facing APIs to communicate data from one system/device to another. The external facing APIs may allow the systems/devices to establish secure communication channels via secure access channels over the networks 125 through any number of methods, such as web-based forms, programmatic access via RESTful APIs, Simple Object Access Protocol (SOAP), remote procedure call (RPC), scripting access, etc.

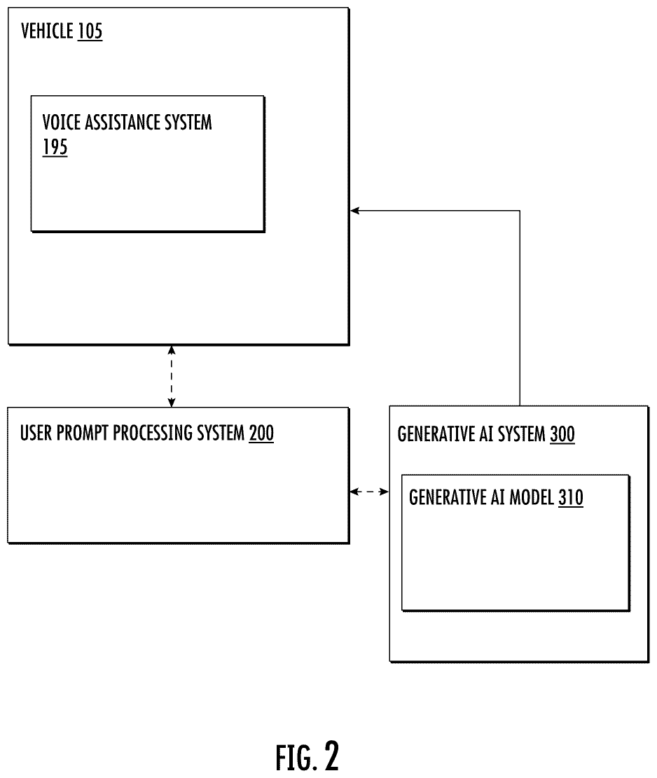

The computing platform 110 may include a computing system that is remote from the vehicle 105. In an embodiment, the computing platform 110 may include a cloud-based server system. The computing platform 110 may include one or more back-end services for supporting the vehicle 105. The services may include, for example, tele-assist services, navigation/routing services, performance monitoring services, etc. The computing platform 110 may host or otherwise include one or more APIs for communicating data to/from a computing system 130 of the vehicle 105 or the user device 115. The computing platform may host or otherwise include the user prompt processing system 200 or a generative AI system 300 as depicted in FIG. 2.

The computing platform 110 may include one or more computing devices. For instance, the computing platform 110 may include a control circuit 185 and a non-transitory computer-readable medium 190 (e.g., memory). The control circuit 185 of the computing platform 110 may be configured to perform the various operations and functions described herein.

In an embodiment, the control circuit 185 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit.

In an embodiment, the control circuit 185 may be programmed by one or more computer-readable or computer-executable instructions stored on the non-transitory computer-readable medium 190.

In an embodiment, the non-transitory computer-readable medium 190 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium 190 may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), or a memory stick. In some cases, the non-transitory computer-readable medium 190 may store computer-executable instructions or computer-readable instructions, such as instructions to perform the operations and methods described herein.

In various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 185 to perform one or more functional tasks. The modules and computer-readable/executable instructions may be described as performing various operations or tasks when a control circuit or other hardware component is executing the modules or computer-readable instructions.

The user device 115 may include a computing device owned or otherwise accessible to the user 120. For instance, the user device 115 may include a phone, laptop, tablet, wearable device (e.g., smart watch, smart glasses, headphones), personal digital assistant, gaming system, personal desktop devices, other hand-held devices, or other types of mobile or non-mobile user devices. As further described herein, the user device 115 may include one or more input components such as buttons, a touch screen, a joystick or other cursor control, a stylus, a microphone, a camera or other imaging device, a motion sensor, etc. The user device 115 may include one or more output components such as a display device (e.g., display screen), a speaker, etc. In an embodiment, the user device 115 may include a component such as, for example, a touchscreen, configured to perform input and output functionality to receive user input and present information for the user 120. The user device 115 may execute one or more instructions to run an instance of a software application and present user interfaces associated therewith. The launch of a software application for a respective transportation platform may initiate a user-network session with the computing platform 110.

The networks 125 may be any type of network or combination of networks that allows for communication between devices. In some implementations, the networks 125 may include one or more of a local area network, wide area network, the Internet, secure network, cellular network, mesh network, peer-to-peer communication link or some combination thereof and may include any number of wired or wireless links. Communication over the networks 125 may be accomplished, for instance, via a network interface using any type of protocol, protection scheme, encoding, format, packaging, etc. Communication between the computing system 130 and the user device 115 may be facilitated by near field or short range communication techniques (e.g., Bluetooth low energy protocol, radio frequency signaling, NFC protocol).

The vehicle 105 may be a vehicle that is operable by the user 120. In an embodiment, the vehicle 105 may be an automobile or another type of ground-based vehicle that is manually driven by the user 120. For example, the vehicle 105 may be a Mercedes-Benz® car or van. In some implementations, the vehicle 105 may be an aerial vehicle (e.g., a personal airplane) or a water-based vehicle (e.g., a boat). The vehicle 105 may include operator-assistance functionality such as cruise control, advanced driver assistance systems, etc. In some implementations, the vehicle 105 may be a fully or semi-autonomous vehicle.

The vehicle 105 may include a power train and one or more power sources. The power train may include a motor, e-motor, transmission, driveshaft, axles, differential, e-components, gear, etc. The power sources may include one or more types of power sources. For example, the vehicle 105 may be a fully electric vehicle (EV) that is capable of operating a powertrain of the vehicle 105 (e.g., for propulsion) and the vehicle's onboard functions using electric batteries. In an embodiment, the vehicle 105 may use combustible fuel. In an embodiment, the vehicle 105 may include hybrid power sources such as, for example, a combination of combustible fuel and electricity.

The vehicle 105 may include a vehicle interior. The vehicle interior may include the area inside of the body of the vehicle 105 including, for example, a cabin for users of the vehicle 105. The interior of the vehicle 105 may include seats for the users, a steering mechanism, accelerator interface, braking interface, etc. The interior of the vehicle 105 may include one or more speakers for providing audio output to a user of the vehicle. The interior of the vehicle 105 may also include a display device such as a display screen associated with an infotainment system configured to provide visual output to a user. Such a component may be referred to as a display device of the infotainment system or be considered as a device for implementing an embodiment that includes the use of an infotainment system. For illustrative and example purposes, such a component may be referred to herein as a head unit display device (e.g., positioned in a front/dashboard area of the vehicle interior), a rear unit display device (e.g., positioned in the back passenger area of the vehicle interior), an infotainment head unit or rear unit, or the like.

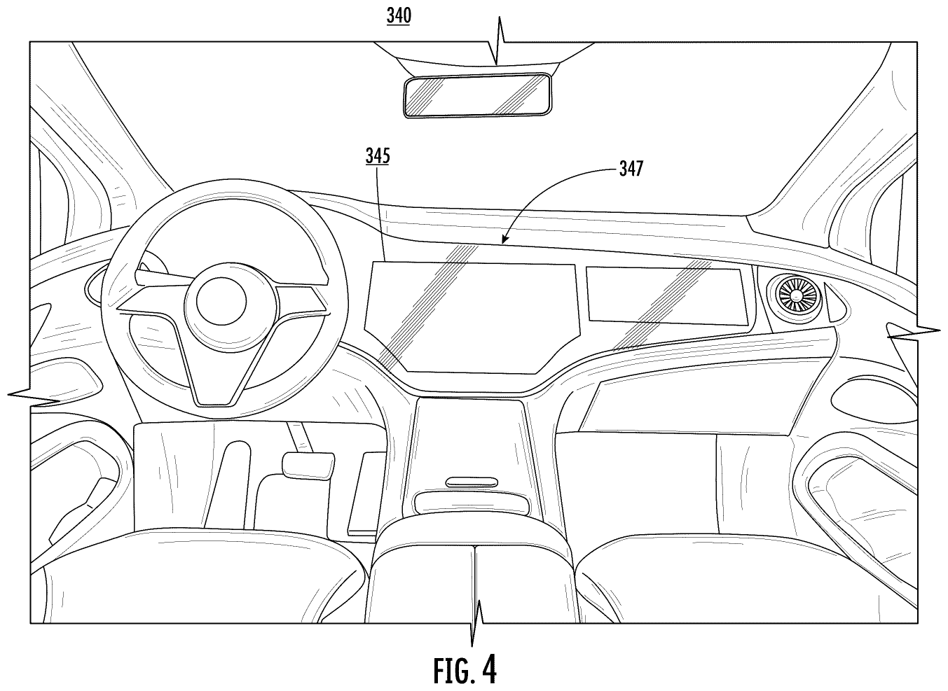

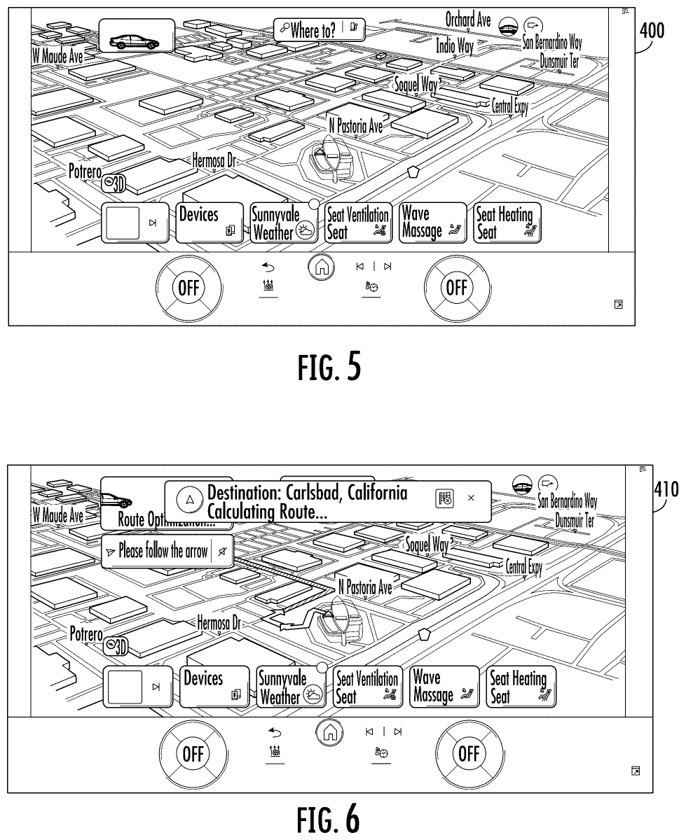

The display device may display a variety of content to the user 120 including information about the vehicle 105, prompts for user input, responses to user queries provided to a voice assistance system, etc. The display device may include a touchscreen through which the user 120 may provide user input to a user interface. The display device may be associated with an audio input device (e.g., microphone) for receiving audio input from the user 120. In some implementations, the display device may function as a dashboard of the vehicle 105. An example display device is illustrated in FIG. 4 and example user interfaces such a display device are depicted in FIGS. 5-17.

The interior of the vehicle 105 may include one or more lighting elements. The lighting elements may be configured to emit light at various colors, brightness levels, etc.

The vehicle 105 may include a vehicle exterior. The vehicle exterior may include the outer surface of the vehicle 105. The vehicle exterior may include one or more lighting elements (e.g., headlights, brake lights, accent lights). The vehicle 105 may include one or more doors for accessing the vehicle interior by, for example, manipulating a door handle of the vehicle exterior. The vehicle 105 may include one or more windows, including a windshield, door windows, passenger windows, rear windows, sunroof, etc.

Certain routine and conventional components of vehicle 105 (e.g., an engine) are not illustrated or discussed herein for the purpose of brevity. One of ordinary skill in the art will understand the operation of conventional vehicle components in vehicle 105.

The vehicle 105 may include a computing system 130 that is onboard the vehicle 105. The computing system 130 may be located onboard the vehicle 105 in that it is included on or within the vehicle 105. The computing system 130 may include one or more computing devices, which may include various computing hardware components. For instance, the computing system 130 may include a control circuit 135 and a non-transitory computer-readable medium 140 (e.g., memory). The control circuit 135 may be configured to perform the various operations and functions for implementing the technology described herein.

In an embodiment, the control circuit 135 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In some implementations, the control circuit 135 or computing system 130 may be part of, or may form, a vehicle control unit (also referred to as a vehicle controller) that is embedded or otherwise disposed in the vehicle 105 (e.g., a Mercedes-Benz® car or van). For example, the vehicle controller may be or may include an infotainment system controller (e.g., an infotainment head-unit), a telematics control unit (TCU), an electronic control unit (ECU), a central powertrain controller (CPC), a charging controller, a central exterior and interior controller (CEIC), a zone controller, or any other controller.

In an embodiment, the control circuit 135 may be programmed by one or more computer-readable or computer-executable instructions stored on the non-transitory computer-readable medium 140.

In an embodiment, the non-transitory computer-readable medium 140 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium 140 may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), or a memory stick. In some cases, the non-transitory computer-readable medium 140 may store computer-executable instructions or computer-readable instructions, such as instructions to perform the methods of FIGS. 18-20. Additionally, or alternatively, similar such instructions may be stored in the computing platform 110 (e.g., the non-transitory computer-readable medium 190) and provided over the networks 125.

The computing system 130 (e.g., the control circuit 135) may be configured to communicate with the other components of the vehicle 105 via a communication channel. The communication channel may include one or more data buses (e.g., controller area network (CAN)), on-board diagnostics connector (e.g., OBD-II), or a combination of wired or wireless communication links. The onboard systems may send or receive data, messages, signals, etc. amongst one another via the communication channel.

In an embodiment, the communication channel may include a direct connection, such as a connection provided via a dedicated wired communication interface, such as a RS-232 interface, a universal serial bus (USB) interface, or via a local computer bus, such as a peripheral component interconnect (PCI) bus. In an embodiment, the communication channel may be provided via a network. The network may be any type or form of network, such as a personal area network (PAN), a local-area network (LAN), e.g., Intranet, a metropolitan area network (MAN), a wide area network (WAN), or the Internet. The network may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol.

In an embodiment, the systems/devices of the vehicle 105 may communicate via an intermediate storage device, or more generally an intermediate non-transitory computer-readable medium. For example, the non-transitory computer-readable medium 140, which may be external to the computing system 130, may act as an external buffer or repository for storing information. In such an example, the computing system 130 may retrieve or otherwise receive the information from the non-transitory computer-readable medium 140.

The vehicle 105 may include one or more human-machine interfaces (HMIs) 145. The human-machine interfaces 145 may include a microphone, a speaker, or a display device, as described herein. The display device (e.g., touchscreen) may be viewable by a user of the vehicle 105 (e.g., user 120, second user 175) that is located in the front of the vehicle 105 (e.g., driver's seat, front passenger seat). Additionally, or alternatively, a display device (e.g., rear unit) may be viewable by a user that is located in the rear of the vehicle 105 (e.g., back passenger seats).

The vehicle 105 may include one or more sensors 150. The sensors 150 may be configured to acquire sensor data. This may include sensor data associated with the surrounding environment of the vehicle 105, sensor data associated with the interior of the vehicle 105, or sensor data associated with a particular vehicle function. The sensor data may be indicated of conditions observed in the interior of the vehicle, exterior of the vehicle, or in the surrounding environment. For instance, the sensor data may acquire image data, inside/outside temperature data, weather data, data indicative of a position of a user/object within the vehicle 105, weight data, motion/gesture data, audio data, or other types of data. The sensors 150 may include one or more: cameras (e.g., visible spectrum cameras, infrared cameras), motion sensors, audio sensors (e.g., microphones), weight sensors (e.g., for a vehicle a seat), temperature sensors, humidity sensors, Light Detection and Ranging (LIDAR) systems, Radio Detection and Ranging (RADAR) systems, or other types of sensors. The vehicle 105 may also include other sensors configured to acquire data associated with the vehicle 105. For example, the vehicle 105 may include inertial measurement units, wheel odometry devices, or other sensors.

The vehicle 105 may include a positioning system 155. The positioning system 155 may be configured to generate position data (also referred to as location data) indicative of a position (also referred to as a location) of the vehicle 105. For example, the positioning system 155 may determine position by using one or more of inertial sensors (e.g., inertial measurement units, etc.), a satellite positioning system, based on IP address, by using triangulation or proximity to network access points or other network components (e.g., cellular towers, WiFi access points, etc.), or other suitable techniques. The positioning system 155 may determine a current location of the vehicle 105. The location may be expressed as a set of coordinates (e.g., latitude, longitude), an address, a semantic location (e.g., “at work”), etc.

In an embodiment, the positioning system 155 may be configured to localize the vehicle 105 within its environment. For example, the vehicle 105 may access map data that provides detailed information about the surrounding environment of the vehicle 105. The map data may provide information regarding: the identity and location of different roadways, road segments, buildings, or other items; the location and directions of traffic lanes (e.g., the location and direction of a parking lane, a turning lane, a bicycle lane, or other lanes within a particular roadway); traffic control data (e.g., the location, timing, or instructions of signage (e.g., stop signs, yield signs), traffic lights (e.g., stop lights), or other traffic signals or control devices/markings (e.g., cross walks)); or any other data. The positioning system 155 may localize the vehicle 105 within the environment (e.g., across multiple axes) based on the map data. For example, the positioning system 155 may process sensor data (e.g., LIDAR data, camera data, etc.) to match it to a map of the surrounding environment to get an understanding of the vehicle's position within that environment. The determined position of the vehicle 105 may be used by various systems of the computing system 130 or provided to the computing platform 110.

The vehicle 105 may include a communications system 160 configured to allow the vehicle 105 (and its computing system 130) to communicate with other computing devices. The computing system 130 may use the communications system 160 to communicate with the computing platform 110 or one or more other remote computing devices over a network 125 (e.g., via one or more wireless signal connections). In some implementations, the communications system 160 may allow communication among one or more of the systems on-board the vehicle 105.

In an embodiment, the communications system 160 may be configured to allow the vehicle 105 to communicate with or otherwise receive data from the user device 115. The communications system 160 may utilize various communication technologies such as, for example, Bluetooth low energy protocol, radio frequency signaling, or other short range or near filed communication technologies. The communications system 160 may include any suitable components for interfacing with one or more networks, including, for example, transmitters, receivers, ports, controllers, antennas, or other suitable components that may help facilitate communication.

The vehicle may include a navigation system 192. The navigation system 192 may be the front-end, client interface component of a navigation service that is hosted or otherwise provided by the remote computing platform 110. For instance, the remote computing platform 110 may include a navigation service (e.g., microservice) that provides a back-end routing and navigation service for the vehicle 105. For example, the navigation service may provide map data to the navigation system 192 of the vehicle 105. The map data may be utilized by the positioning system 155 of the vehicle 105 to determine a location of the vehicle 105, a point of interest, etc. The navigation service may also provide routes to destinations requested via the navigation system 192 onboard the vehicle 105, (e.g., via user input to the vehicle's head unit, voice query/command to a microphone). The routes can be provided as a portion of the map data or as separate routing data. The navigation system 192 may be configured to send and receive signals (e.g., GPS signals) indicative of the location of the vehicle 105. Data provided by the backend navigation service to the navigation system 192, as well as data generated by the navigation system 192, can be presented as content via a software application on a display device of the vehicle 105 (e.g., a display device of the head unit).

The vehicle may include a voice assistance system 195. The voice assistance system 195 may include a digital assistant that uses speech recognition, natural language processing, artificial intelligence, etc. to understand and respond to voice commands or queries from a first user 120 (e.g., driver) or a second user 175 (e.g., passenger) of the vehicle 105. The voice assistance system 195 may be configured to perform various tasks and provide information, such as answering questions, setting reminders, playing music, providing weather updates, location-based suggestions, etc.

The voice assistance system 195 may be configured to communicate with a backend voice assistance service 197 of the remote computing platform 110. The backend voice assistance service 197 may be a microservice configured to receive data indicative of the user input provided by the user 120 (e.g., digitized version of the user's voice command). In response, the backend voice assistance service 197 may process and interpret the user input. For instance, the backend voice assistance service 197 may be configured to perform speech recognition for converting spoken words into text and natural language understanding (NLU) for analyzing the text to understand the user's intent and extract relevant information. The backend voice assistance service 197 may be configured to perform the requested action or retrieve the necessary information. To do so, the backend voice assistance service 197 may communicate with other services or APIs to fulfill user requests (e.g., checking the weather, searching the web). The backend voice assistance service 197 may formulate a response in natural language to provide to the user and provide data indicative of the response to the voice assistance system 195 of the vehicle 105. The voice assistance system 195 may process the data indicative of the response and generate an output that can be provided to the user 120 via the vehicle's HMIs 145 (e.g., a speaker, a display device).

As will be further described herein, voice assistance system 195 and backend voice assistance service 197 may utilize machine learning models and large datasets to perform their functions.

The vehicle 105 may include a plurality of vehicle functions 165A-C. A vehicle function 165A-C may be a functionality that the vehicle 105 is configured to perform based on a detected input. The vehicle functions 165A-C may include one or more: (i) vehicle comfort functions; (ii) vehicle staging functions; (iii) vehicle climate functions; (vi) vehicle navigation functions; (v) drive style functions; (v) vehicle parking functions; or (vi) vehicle entertainment functions.

The vehicle comfort functions may include a window function (e.g., for a door window, sunroof), a seat function, a wall function, a steering wheel function, a pedal function or other comfort functions. In an embodiment, the seat function may include, for example, a seat temperature function that controls the temperature of the seat. This may include a specific temperature (e.g., in degrees C./F) or a temperature level (e.g., low, medium, high). In an embodiment, the seat function may include a seat ventilation function for controlling the ventilation system of a seat.

In an embodiment, the seat function may include a seat massage function for controlling the massager devices within a seat. The seat massage function may have one or more levels, each reflective of the intensity of the massage. The seat massage function may have one or more programs/settings, each reflective of a different type or combination of massage. In an embodiment, the seat function may include a seat position function for controlling a position of a seat in one or more directions, for example forward/backward or up/down.

A pedal function may control a position of one or more pedal controls (e.g., a brake pedal, an accelerator pedal) relative to a user's feet. A wall function may control the temperature of the vehicle interior wall or door.

A steering wheel function may control a temperature, position, or vibration of the steering wheel.

The vehicle staging functions may control the interior lighting of the vehicle 105. In an embodiment, the vehicle staging functions may include an interior lighting function. For example, the interior lighting function may control the color, brightness, intensity, etc. of the interior lights of the vehicle 105 (e.g., the ambient lighting). In an embodiment, the vehicle staging functions may include one or more predefined lighting programs or combinations. The programs may be set by the user or pre-programed into the default settings of the vehicle 105. In some implementations, the vehicle staging functions may include an exterior lighting function. For example, the exterior lighting function may control accent lighting under or otherwise located along the exterior of the vehicle 105.

The vehicle climate functions may control the interior climate of the vehicle 105. In an embodiment, the vehicle climate functions may include an air conditioning/heating function for controlling the air conditioning/heating system or other systems associated with setting the temperature within the cabin of the vehicle 105. In an embodiment, the vehicle climate functions may include a defrost or fan function for controlling a level, type, or location of air flow within the cabin of vehicle 105. In an embodiment, the vehicle climate functions may include an air fragrance function for controlling a fragrance within the interior of the vehicle 105.

The vehicle navigation functions may control the vehicle's system for providing a route to a particular destination. For example, the navigation system 192 may provide a route to the user 120 for travelling to a destination. As described herein, the navigation system 192 may leverage map data and global positioning system (GPS) based signals to provide guidance to the user 120 via a display device within the interior of the vehicle 105.

The vehicle parking functions may control the vehicle's parking-related features. In an embodiment, the vehicle parking function may include a parking camera function that controls a side, rear, or three-hundred-sixty-degree camera to assist a user 120 when parking the vehicle 105. Additionally, or alternatively, the vehicle parking function may include a parking assistance function that helps to maneuver the vehicle 105 into a parking area.

The vehicle entertainment functions may control one or more entertainment-related features of the vehicle 105. For example, the vehicle entertainment functions may include a radio function for controlling a radio or a media function for controlling another source of audio or visual media. The vehicle entertainment functions may control sound parameters (e.g., volume, bass, treble, speaker distribution) or select a radio station or media content type/source.

Each vehicle function may include a controller 170A-C associated with that particular vehicle function 165A-C. The controller 170A-C for a particular vehicle function may include control circuitry configured to operate its associated vehicle function 165A-C. For example, a controller may include circuitry configured to turn the seat heating function on, to turn the seat heating function off, set a particular temperature or temperature level, etc.

In an embodiment, a controller 170A-C for a particular vehicle function may include or otherwise be associated with a sensor that captures data indicative of the vehicle function being turned on or off, a setting of the vehicle function, etc. For example, a sensor may be an audio sensor or a motion sensor. The audio sensor may be a microphone configured to capture audio input from the user 120. For example, the user 120 may provide a voice command to activate the radio function of the vehicle 105 and request a particular station. The motion sensor may be a visual sensor (e.g., camera), infrared, RADAR, etc. configured to capture a gesture input from the user 120. For example, the user 120 may provide a hand gesture motion to adjust a temperature function of the vehicle 105 to lower the temperature of the vehicle interior.

The controllers 170A-C may be configured to send signals to the control circuit 135 or another onboard system. The signals may encode data associated with a respective vehicle function. The encoded data may indicate, for example, a function setting, timing, etc.

The user 120 may interact with a vehicle function 165A-C through user input (e.g., through the voice assistance system 185). The user input may specify a setting of the vehicle function 165A-C selected by the user (a “user-selected setting”). In an embodiment, a vehicle function 165A-C may be associated with a physical interface such as, for example, a button, a knob, a switch, a lever, a touch screen interface element, or other physical mechanism. The physical interface may be physically manipulated to control the vehicle function 165A-C in accordance with the user-selected setting. By way of example, a user 120 may physically manipulate a button associated with a seat massage function to set the seat massage function to a level five massage intensity. In an embodiment, the user 120 may interact with a vehicle function 165A-C via a user interface element presented on a user interface of a display device (e.g., of a head unit infotainment system).

FIG. 2 illustrates an example system for providing voice assistance in a vehicle according to an embodiment hereof. For example, a voice assistance system 195 can provide assistance to a user, such as a driver or passenger of a vehicle (e.g., vehicle 105 of FIG. 1). More particularly, a voice assistance system 195 of a vehicle 105 may be integrated with a generative artificial intelligence (AI) system 300, and more specifically with a large language model (LLM) system.

The voice assistance system 195 may be located in the vehicle 105, and may communicate with a user prompt processing system 200 located remote from the vehicle 105. For instance, the user prompt processing system 200 may be a cloud-based platform that communicates with the voice assistance system 195 via a network (e.g., network 125 of FIG. 1), and may process voice prompts received by the voice assistance system (and may process other user prompts). The user prompt processing system 200 may be included or otherwise associated with the voice assistance service 197. As discussed below, the voice assistance system 195 or user prompt processing system 200 may perform a validation function, to validate a response or other output from the generative AI system 300. The user prompt processing system 200 or the generative AI system 300 may be provided as part of computing platform 110 or computing system 130 (of the vehicle) as depicted in FIG. 1.

In an example embodiment, the user prompt processing system 200 may have been trained using terminology from a user guide specific to the vehicle 105. In this way, when a user voice prompt includes queries or requests that are specific to a function of a particular type of vehicle 105 (e.g., adjusting ambient lighting), such function can be readily recognized and potentially processed by one or more vehicle systems without needing to be processed by the generative AI system 300.

In an example embodiment, the voice assistance system 195 may receive a first voice prompt (e.g., a voice query) from a user 120 of the vehicle 105. The voice assistance system 195 may include, or otherwise have access to, one or more microphones or other sound sensors configured to capture or otherwise sense the first voice prompt (e.g., “Hey Mercedes, suggest a national park to drive to from Sunnyvale”). For example, the voice assistance system 195 may be part of an automotive head unit/infotainment system.

In some implementations, the voice assistance system 195 may include one or more processors that are configured to perform a transcription, speech recognition, or speech-to-text function. In some implementations, the transcription, speech recognition, or speech-to-text function may be performed on the user prompt processing system 200 (e.g., based on audio data captured by the one or more microphones). As mentioned above, the user prompt processing system 200 may be, or included within, a cloud-based platform that supports the voice assistance system with additional processing power/capabilities. The transcription, speech recognition, or speech-to-text function may generate a first prompt message that is, for example, a full transcription of the first voice prompt, or a partial transcription (e.g., “suggest a national park to drive to from Sunnyvale”) or modified transcription of the first voice prompt. If the transcription or voice recognition function is performed by the voice assistance system 195 on the vehicle 105, then the user prompt processing system 200 may be omitted, or may receive the first prompt message from the voice assistance system 195 and may determine whether the first prompt message needs to be modified (e.g., to add context information).

In an embodiment, the user prompt processing system 200 or the voice assistance system 195 may communicate the first prompt message (e.g., “suggest a national park to drive to from Sunnyvale”) to the generative AI system 300, which may process the first prompt message with a generative AI model (e.g., machine-learned large language model 310) to generate a response based on the first prompt message. In some instances, the generative AI system 300 may be an LLM system (e.g., ChatGPT), and the generative AI model may be a LLM model (e.g., GPT4). Accordingly, the LLM system may generate a response (an “AI system response”) based on the first prompt message.

The user prompt processing system 200 or voice assistance system 195 may receive the AI system response (e.g., a digital message), and generate a voice response for the user. The voice response may be generated via a speech synthesis function that, for example, converts the AI system response to a voice response. In some instances, the speech synthesis function may generate an audio file or audio stream, and may be performed on the user prompt processing system 200 or the voice assistance system 195. In some instances, the voice assistance system 195 may include, or have access to, one or more speakers configured to play the audio file or audio stream within the interior of the vehicle 105.

Additionally or alternatively, the user prompt processing system 200 or the voice assistance system 195 may receive the AI system response (e.g., a digital message), and generate a graphical response for the user. The graphical response may be generated via an image processing function that, for example, converts the AI system response to a graphical response. In some instances, the image processing function may generate an image or video file, and may be performed on the user prompt processing system 200 or the voice assistance system 195. In some instances, the voice assistance system 195 may include, or have access to, one or more touchscreens or other display devices to provide the graphical response as visual output to the user of the vehicle 105.

In an embodiment, the user prompt processing system 200 or the voice assistance system 195 may not communicate the first prompt message to the generative AI system 300. For example, if the user of the vehicle wants to control the vehicle environmental setting, there is no need to communicate with the generative AI system 300.

As discussed above, one aspect of the disclosure further relates to validating the AI system response, before sharing the AI system response with the user or before generating the voice response based on the AI system response. In an example, the validation may involve generating a graphical response (or other visual response) based on the AI system response, and displaying the graphical response through a screen or other user interface of the head unit of the vehicle. In another example, the response is displayed in the head unit and also read out aloud by the voice assistance system.

In an example, a user provides a voice prompt to the voice assistance system, by saying: “Hey Mercedes, suggest a national park to drive to from Sunnyvale”. The voice assistance system 195 or user prompt processing system 200 may generate a prompt message (e.g., a digital message) that is based on the voice prompt, and communicates the prompt message to generative AI system 300. The generative AI system 300 may generate an AI system response that identifies one or more parks around Sunnyvale (e.g., “Yosemite National Park is a great choice for a drive from Sunnyvale. It's about a three-hour drive, and you'll get to see some of the most stunning scenery in the United States.”). The generative AI system 300 sends the AI system response to the user prompt processing system 200 or voice assistance system 195. The voice assistance system 195 outputs a voice response that reads out aloud, for example, “Yosemite National Park is a great choice for a drive from Sunnyvale. It's about a three-hour drive, and you'll get to see some of the most stunning scenery in the United States.” In some instances, the voice response may be a modified version of the AI system response. In some instances, the voice response may be an exact text-to-speech replication of the AI system response.

In an example embodiment, the head unit of the vehicle displays Yosemite National Park as Point of Interest in the head unit of the vehicle 105. The vehicle may start route guidance to Yosemite National Park if the user taps on Yosemite National Park.

In an example embodiment, the user prompt processing system 200 may validate the AI system response based on, for example, real addresses in real time. So if “Hey Mercedes” shows Yosemite National Park as Point of Interest on the head unit, the user prompt processing system 200 compares the address response generated by the generative AI system 300 and compares it with the address of Yosemite National Park as presented in vehicle navigation data accessed via a database storing such information. This comparison can help confirm that the address is up-to-date and the user is provided with the up-to-date route guidance. In case, the address response generated by the generative AI system 300 is not up-to-date, the user prompt processing system 200 may override the vehicle navigation data on the address response generated by the generative AI model (e.g., machine-learned large language model 310).

In an example embodiment, generative AI system 300 (or generative AI model 310) may scan the internet to formulate complex answers from billions of words. For example, the generative AI system 300 may interface with other systems or APIs. This may include integration with web scraping techniques or utilize APIs from search engines to fetch relevant information from the web based on user queries.

The integration of the voice assistance system 195 of a vehicle 105 with the generative AI system 300, may provide the user 120 of the vehicle 105 the opportunity to access a plurality of different automated tasks. This can include automated answers to user queries, retrieval of sports/news information, weather updates, vehicle climate control, smart home device control, restaurant recommendations, content creation (e.g., story writing), retrieval of information about landmarks or other points of interest (e.g., gas stations), and other automated computing functions.

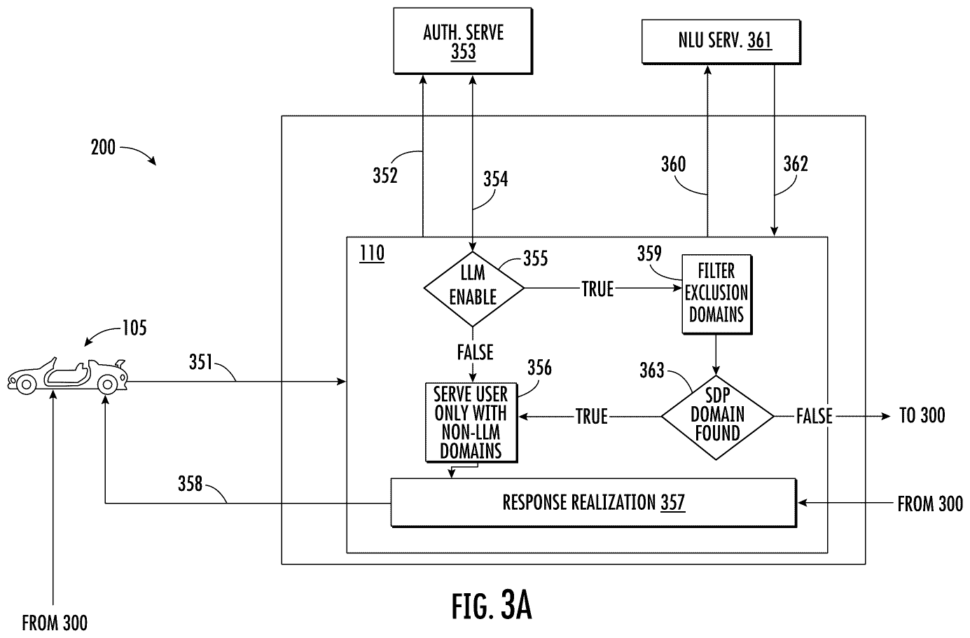

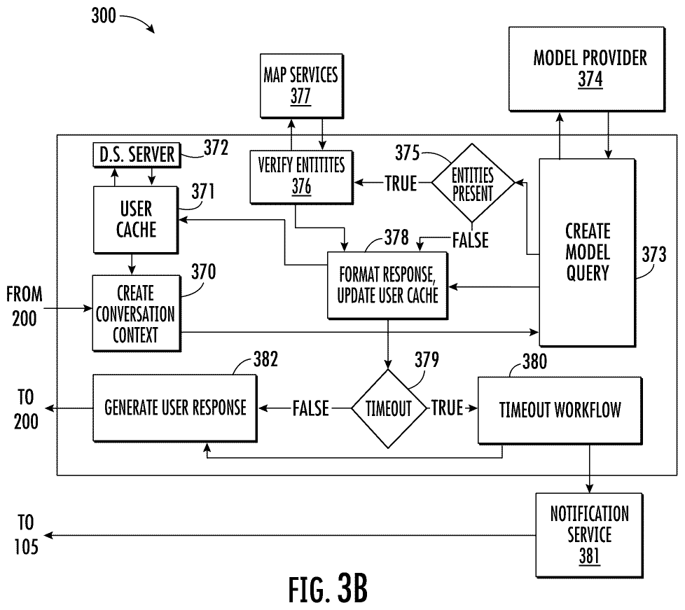

FIG. 3A illustrates an example dataflow for a user prompt processing system 200 for providing voice assistance in a vehicle according to an embodiment hereof. At (351), data indicative of a user request can be transmitted from the vehicle 105 (e.g., via the voice assistance system 195) to the user prompt processing system 200. The user request may include a request from the user 120 for navigation to a particular point of interest, a request for a suggested restaurant in a certain geographic region, or a request to adjust the temperature of the vehicle's interior. The data indicative of the user request may include a request object (with user information). This data may be received by the computing core of the user prompt processing system 200, which can include, or otherwise be associated with, the backend voice assistance service 197.

At (352), the data indicative of the user request may be utilized to authenticate the user 120. For instance, this data may be transmitted to an authentication service 353 (e.g., a third party service, microservice). The authentication service 353 may be configured to perform “Automatic Speech Recognition” (ASR). ASR technology may allow the authentication service 353 to authenticate the user 120 based on the user's voice (e.g., reflected in the user request). The authentication service 353 may analyze and recognize patterns in the user's spoken language (e.g., provided via a voice input), to verify the identity of the user 120. This can be accomplished by converting spoken words into text and then matching that text against stored voiceprints or passphrases to confirm the user's identity. The authentication service 353 may be configured to perform one or more other authentication techniques.

At (354), the authentication service 353 may transmit data indicating whether, or not, the user 120 is authenticated/enrolled to utilize the generative AI model 310. If not, at (355), the user prompt processing system 200 may determine that the user 120 is only to be served with certain domains (e.g., non-LLM domains) including, for example, systems/services that are configured to process and respond to the user request without using an LLM model. The user 120 may be provided with a response via one or more services that may be able to facilitate response realization 357 and transmit a response to the vehicle 105 at (357) in a format ingestible by the voice assistance system 195.

In the event that, at (355), the authentication service 354 confirms that the user 120 is enrolled with a service providing the voice assistance via the generative AI model 310 (e.g., an LLM), the computing platform 110 may be configured to filter exclusion domains, at (359). For instance, at (360), the data indicative of the user request may be provided to a natural language understanding service (NLU) service 361 for processing. This may include a transcription of the user's query as well as domain-intention information.

The NLU service 361 may be configured to interpret and derive meaning from the user's language in the user request. More particularly, the NLU service 361 may be configured to perform language parsing (e.g., to break down sentences into grammatical components (words, phrases) and understand their syntactic structure) and semantic analysis (e.g., understanding the meaning of words/phrases/etc. within a given context). In some example embodiments, the NLU service 361 may be configured to perform named entity recognition (NER) to identify and categorize entities mentioned in text, such as names of people, organizations, locations, dates, etc. The NLU service 361 may be configured to perform intent recognition to determine the intention or purpose behind the user request of the user 120. Additionally, or alternatively, the NLU service 361 may be configured to perform coreference resolution for resolving references in a text to entities that have already been indicated in user requests.

In some example embodiments, the authentication service 353 may authenticate the user 120 asynchronously with the NLU service 361 processing the user's request. The NLU service 361 may be a microservice of the computing platform 110 or accessed from a third-party provider (e.g., via an API).

The NLU service 361 may perform these functions and return a response to the user prompt processing system 200, at (362). This may allow the user prompt processing system 200 to determine whether a particular service domain platform (SDP) is identified in, or otherwise associated with, the user request. At (363), in the event it is determined that a particular SDP domain is associated with the user request (e.g., the user request is a type to be processed with an non-LLM) the user request can be processed with non-LLM domains and the data flow may continue at (357) and (358). Otherwise, the user's request may be provided for processing via the dataflow in FIG. 3B, using a generative AI system 300.

FIG. 3B illustrates an example dataflow for a generative AI system 300 for providing voice assistance in a vehicle according to an embodiment hereof. For instance, at (370), the generative AI system 300 may create a conversation context. The generative AI system 300 may process the data indicative of the user request, a transcription thereof, an authentication identifier (e.g., associated with the user 120), associated headers, etc.

The generative AI system 300 may be configured to create the conversation context by maintaining and updating information relevant to the user request. For instance, in the context of an LLM (e.g., a generative pre-trained transformer), creating conversation context may include accessing information about previous utterances, questions, or prompts in the conversation. This context can help the LLM generate more coherent and relevant responses by understanding the flow of the conversation and considering the preceding context when generating a response.

To help create the conversation context, the generative AI system 300 may access a user cache 371 associated with the user 120. The user cache 371 may be configured to store (or otherwise maintain) a history of the conversation of the user 120 with the voice assistance system 195 (e.g., including previous utterances, questions, prompts from the user 120, model responses). The user cache 371 may be associated with a data structure server 372 that is configured to store, provide access to, etc. a plurality of different data structures (e.g., strings, lists, sets, hashes, sorted sets, bitmaps, indexes) that may be used to store the information for the user cache 371. This context might also, or alternatively, include information about the user's preferences, previous queries, the current topic associated with the user request, etc.

At (373), the generative AI system 300 may create a model query with user and system configurations. For instance, the generative AI system 300 may create a query based on the specific configurations associated with the generative AI model 310 or a third-party model provider 374 associated therewith. Such configurations may be exposed via an API or other publication approaches. The query may include conversation context associated with the user's request. The query can include a system prompt. The generative AI system 300 may provide data indicative of the user request (e.g., in the system prompt). As described herein, the generative AI model 310 (e.g., a LLM) may process the data indicative of the user request and provide a response. The response may indicate one or more entities (or the detection thereof). The entities may include names, places, locations, etc.

At (375), the generative AI system 300 may determine whether any entities were indicated in the response from the generative AI model 310 (e.g., the LLM model). If yes, at (376), the generative AI system 300 may be configured to verify the entities. By way of example, in the event that the entity is a location, the generative AI system 300 may interface with one or more map services 377 (e.g., via an API call). The map services 377 may be configured to access an address of the entity or verify that an entity indicated in the response is within the relevant geographic area.

At (378), the generative AI system 300 may format a response to the user 120 and update the user cache 371. For instance, the generative AI system 300 may format a response that can be packaged and transmitted to the vehicle 105 for ingestion by the voice assistance system 195 (e.g., for communication to the user 120).

At (379), the generative AI system 300 may determine whether a timeout may be appropriate. The timeout may be based on a limit imposed on the amount of time allowed for a computational task (e.g., for generating the response to the user request via an LLM) to complete. When this limit is reached, the task may be terminated, and the generative AI system 300 may return an error or interrupt the process.

If a timeout is appropriate, at (380) a timeout workflow may be initiated. This workflow may include the provision of an intermediate user response. Additionally, or alternatively, the timeout workflow may include communication with a notification service 381, which can initiate the transmission of a notification to the vehicle 105 (e.g., an error message, message indicating a delay).

At (382), the generative AI system 300 may generate a user response. This may occur in the event a timeout is not appropriate or an intermediate user response is generated. The response may include text-to-speech (TTS) as well as textual content for presentation via a user interface. The voice assistance system 195 may be configured to process the TTS response such that the voice assistance system 195 can output the response via the HMIs 145 (e.g., speakers, display screen) of the vehicle 105.

FIG. 4 illustrates an example vehicle interior 340 with a display device 345. The display device 345 may be a component of the vehicle's infotainment system. Such a component may be referred to as a display device of the infotainment system or be considered as a device for implementing an embodiment that includes the use of an infotainment system. For illustrative and example purposes, such a component may be referred to herein as a head unit display device (e.g., positioned in a front/dashboard area of the vehicle interior), a rear unit display device (e.g., positioned in the back passenger area of the vehicle interior), an infotainment head unit or rear unit, or the like. The display device 345 may be located on, form a portion of, or function as a dashboard of the vehicle 105. The display device 345 may include a display screen, CRT, LCD, plasma screen, touch screen, TV, projector, tablet, or other suitable display components.

The display device 345 may display a variety of content to the user 120 including information about the vehicle 105, prompts for user input, etc. The display device 345 may include a touchscreen through which the user 120 may provide user input (e.g., user action) to a user interface.

For example, the display device 345 may include user interface rendered via a touch screen that presents various content. The content may include vehicle speed, mileage, fuel level, charge range, or one or more software applications such as navigation/routing information, audio selections, streaming content (e.g., video/image content), internet search results, comfort settings (e.g., temperature, humidity, seat position, seat massage), or other vehicle data.

The display device 345 may render content to facilitate the receipt of user input. For instance, the user interface of the display device 345 may present one or more soft buttons with which a user 120 can interact to adjust various vehicle functions through a software application 245 (e.g., navigation, audio/streaming content selection, temperature, seat position, seat massage, etc.).

In an example embodiment, the display device 345 may present one or more points of interest based on a user query submitted to a voice assistance system 185, as described herein. Each point of interest may be presented as a soft button selectable by user touch input. In response to user selection of a particular point of interest, display device 345 can transition to providing navigation directions to the point of interest as a user interface for display to the user of the vehicle 105. Additionally, or alternatively, the display device 345 may be associated with an audio input device (e.g., microphone) for receiving audio input from the user 120 and an audio output device (e.g., a speaker) for providing audio output to the user 120.

In a first example, FIGS. 5-10 illustrate content for presentation to the user 120 in response to various queries provided to a voice assistance system 195 according to example embodiments. For example, a digital message response (e.g., AI system response) may be presented as audio content for output via a speaker or visual content for output as various user interfaces 400-450 via display device 345 (e.g., onboard the vehicle 105). The user 120 may interact with the user interface (e.g., via one or more user interface elements) to select or accept information or options presented as part of the digital message response.

In the first example of FIGS. 5-10, a display device 345 may provide a user interface 400 in FIG. 5 that corresponds to a home screen for a voice assistance system 195 of a vehicle 105. The home screen depicted in user interface 400 may include map data of an environment surrounding vehicle 105, such as determined by positioning system 155 or navigation system 192 based on a current location of the vehicle 105.

A first voice prompt indicative of a speech-based voice query may be provided by a user 120 of the vehicle 105 while the home screen is displayed on user interface 400. In some examples, a triggering voice prompt that includes one or more particular trigger words or trigger phrases may be provided by a user 120 of the vehicle 105 to engage the voice assistance system 195 before a voice prompt indicative of a query may be provided. The voice assistance system may be configured to regularly monitor user input to a vehicle microphone for speech-based content from the user 120 corresponding to the particular trigger words/phrases. For instance, detection of a user providing a triggering voice prompt such as “Hey Mercedes” may initiate engagement of the voice assistance system 195. In response to detection of the triggering voice prompt by the voice assistance system 195, an acknowledgement response may be provided as audio output or video output to the user 120 of the vehicle 105. For instance, an audio output such as “How can I help?” may be generated by voice assistance system 195 and provided to the user 120 of the vehicle 105. After hearing the acknowledgement response, a first voice prompt may be provided by the user 120 of the vehicle 105 corresponding to, “Navigate to Carlsbad.” This particular voice prompt may seek to engage a navigation function of the voice assistance system 195.

Based on the first voice prompt “Navigate to Carlsbad”, the voice assistance system 195 may determine a first prompt message corresponding to a text-based transcription of the first voice prompt. The voice assistance system 195 or the user prompt processing system 200 may determine a type of the first prompt message as one of a first type for processing by a vehicle system onboard the vehicle 105 or a second type for processing by the generative AI system 300 (e.g., the machine-learned large language model 310). In this case, because the first prompt message corresponding to the first voice prompt “Navigate to Carlsbad” is seeking to engage a navigation function, the first prompt message may be determined as a first type for processing by a vehicle system onboard the vehicle 105.

The first prompt message may then be processed by the navigation system 192 onboard the vehicle 105. A digital message response may be provided by the navigation system 192 based on the first prompt message corresponding to the first voice prompt “Navigate to Carlsbad.” In some examples, the digital message response may be converted to a speech-based voice response corresponding to “Route guidance to Carlsbad California is starting,” which is provided as audio output to the user 120 of the vehicle 105. In some examples, the digital message response may be converted to a graphical response corresponding to the navigation route and associated instructions provided via user interface 410 of FIG. 6.

Continuing with the first example of FIGS. 5-10, a second voice prompt indicative of a speech-based voice query may be provided by a user 120 of the vehicle 105 while the navigation route to Carlsbad, California is displayed on user interface 410, a second voice prompt may be provided by the user 120 of the vehicle 105 corresponding to, “How's the weather in Carlsbad?” This particular voice prompt may seek to engage a weather function of the voice assistance system 195.

Based on the second voice prompt “How's the weather in Carlsbad?”, the voice assistance system 195 may determine a second prompt message corresponding to a text-based transcription of the second voice prompt. The voice assistance system 195 or the user prompt processing system 200 may determine a type of the second prompt message as one of a first type for processing by a vehicle system onboard the vehicle 105 or a second type for processing by the generative AI system 300 (e.g., the machine-learned large language model 310). In this case, because the second prompt message corresponding to the second voice prompt “How's the weather in Carlsbad?” is seeking to engage a weather function, the second prompt message may be determined as a second type for processing by the generative AI system 300.

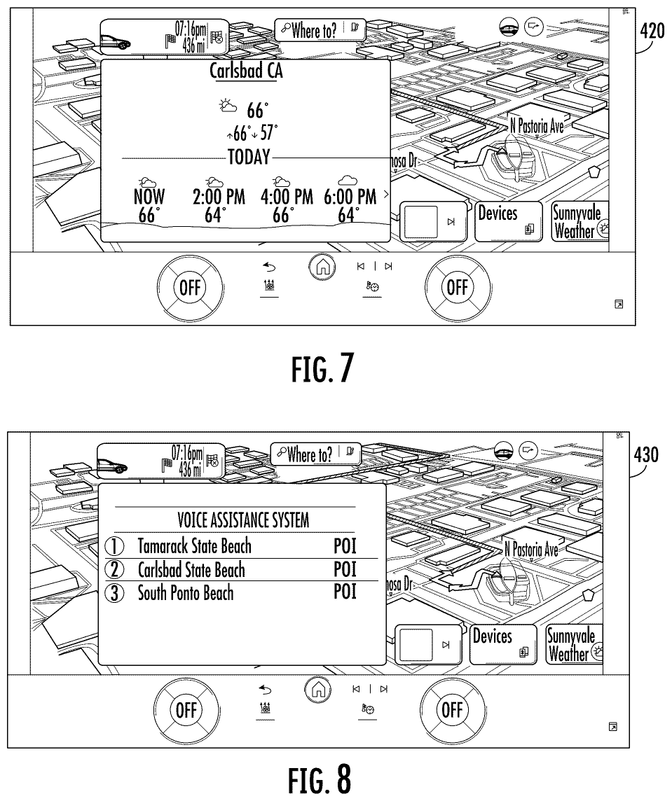

The second prompt message may then be processed by the machine-learned large language model 310. A digital message response may be generated by machine-learned large language model 310 and provided by the generative AI system 300 based on the second prompt message corresponding to the second voice prompt “How's the weather in Carlsbad?” In some examples, the digital message response may be converted to a speech-based voice response corresponding to “The weather is overcast and 66 degrees in Carlsbad,” which is provided as audio output to the user 120 of the vehicle 105. In some examples, the digital message response may be converted to a graphical response corresponding to the weather forecast information for Carlsbad, California provided via user interface 420 of FIG. 7.

Still further, a third voice prompt indicative of a speech-based voice query may be provided by a user 120 of the vehicle 105 while the weather forecast for Carlsbad, California is displayed on user interface 420, a third voice prompt may be provided by the user 120 of the vehicle 105 corresponding to, “I feel like digging my feet into the sand. What beaches would you recommend around Carlsbad?” This particular voice prompt may seek to engage a local search function of the voice assistance system 195.

Based on at least a portion of the third voice prompt “What beaches would you recommend around Carlsbad?”, the voice assistance system 195 may determine a third prompt message corresponding to a text-based transcription of the third voice prompt. The voice assistance system 195 or the user prompt processing system 200 may determine a type of the third prompt message as one of a first type for processing by a vehicle system onboard the vehicle 105 or a second type for processing by the generative AI system 300 (e.g., the machine-learned large language model 310). In this case, because the third prompt message corresponding to the third voice prompt “What beaches would you recommend around Carlsbad?” is seeking to engage a local search function, the third prompt message may be determined as a second type for processing by the generative AI system 300.

The third prompt message may then be processed by the generative AI model 310 (e.g., a machine-learned large language model). A digital message response may be generated by the generative AI model 310 and provided by the generative AI system 300 based on the third prompt message corresponding to the third voice prompt “What beaches would you recommend Carlsbad?” In some examples, the digital message response may be converted to a speech-based voice response corresponding to “Carlsbad has several beautiful beaches that you might want to check out. One option is Tamarack State Beach, which is a popular spot for swimming, surfing, and sunbathing. Another nearby option is Carlsbad State Beach, which has a long stretch of sand and is great for beachcombing and tidepooling. If you're looking for a more secluded spot, South Ponto Beach is a great option. It's a bit further South, but it's a quieter spot with nice waves for surfing. I hope that helps.” This voice response may be provided as audio output to the user 120 of the vehicle 105. In some examples, the digital message response may be converted to a graphical response corresponding to the different beaches recommended near Carlsbad, California provided via user interface 430 of FIG. 8.

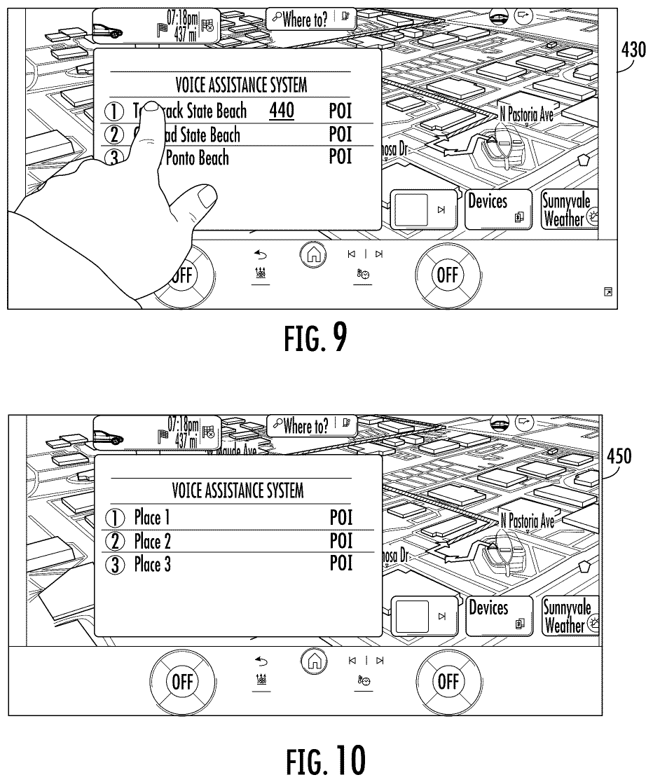

Continuing still with the first example of FIGS. 5-10, user touch input may be provided by a user 120 of the vehicle 105 while the beach options near Carlsbad, California are displayed on user interface 430. For example, as shown in FIG. 9, a finger of user 120 may be provided to select a soft button 440 on user interface 430 corresponding to one of the different beaches recommended near Carlsbad, California, namely Option 1 for Tamarack State Beach. Selection by user 120 of soft button 440 may serve to engage navigation system 192 of the vehicle 105 to determine vehicle navigation instructions to the selected location of Tamarack State Beach.

A digital message response may be provided by the navigation system 192 based on the user selection of soft button 440. In some examples, the digital message response may be converted to a speech-based voice response corresponding to “Route guidance to Tamarack State Beach is starting,” which is provided as audio output to the user 120 of the vehicle 105. In some examples, the digital message response may be converted to a graphical response corresponding to the navigation route and associated instructions provided via another user interface on display device 345.

Still further, a fourth voice prompt indicative of a speech-based voice query may be provided by a user 120 of the vehicle 105 while route guidance to Tamarack State Park is displayed on a user interface. For example, a fourth voice prompt may be provided by the user 120 of the vehicle 105 corresponding to, “I feel like exploring after the beach. What museums would you recommend in the area?” This particular voice prompt may seek to engage a local search function of the voice assistance system 195.

Based on at least a portion of the fourth voice prompt “What museums would you recommend in that area?”, the voice assistance system 195 may determine a fourth prompt message corresponding to a text-based transcription of the fourth voice prompt. The voice assistance system 195 or the user prompt processing system 200 may determine a type of the fourth prompt message as one of a first type for processing by a vehicle system onboard the vehicle 105 or a second type for processing by the generative AI system 300 (e.g., by the machine-learned large language model). In this case, because the fourth prompt message corresponding to the fourth voice prompt “What museums would you recommend in that area?” is seeking to engage a local search function, the fourth prompt message may be determined as a second type for processing by the generative AI system 300.

The fourth prompt message may then be processed by the generative AI model 310 (e.g., a machine-learned large language model). A digital message response may be generated by generative AI model 310 and provided by the generative AI system 300 based on the fourth prompt message corresponding to the fourth voice prompt “What museums would you recommend in that area?” In some examples, the digital message response may be converted to a speech-based voice response corresponding to “If you're looking for museums in the Carlsbad area, there are several options to choose from. One option is the Place 1, which is dedicated to showcasing the history of musical instruments and the music products industry. Another option is Place 2 which displays a collection of gems, minerals, and jewelry. Finally, Place 3 in nearby Oceanside is a great option if you're interested in surfing culture and history. I hope that helps.” This voice response may be provided as audio output to the user 120 of the vehicle 105. In some examples, the digital message response may be converted to a graphical response corresponding to the different museums recommended near Carlsbad, California provided via user interface 450 of FIG. 10.

Finally, a fifth voice prompt indicative of a speech-based voice query may be provided by a user 120 of the vehicle 105 while the museum options near Carlsbad, California are displayed on user interface 420. A fifth voice prompt may be provided by the user 120 of the vehicle 105 corresponding to, “What special cuisine can I get in that area?” This particular voice prompt may seek to engage a local search function of the voice assistance system 195.

Based on the fifth voice prompt “What special cuisine can I get in that area?”, the voice assistance system 195 may determine a fifth prompt message corresponding to a text-based transcription of the fifth voice prompt. The voice assistance system 195 or the user prompt processing system 200 may determine a type of the fifth prompt message as one of a first type for processing by a vehicle system onboard the vehicle 105 or a second type for processing by the generative AI system 300 (e.g., the machine-learned large language model). In this case, because the fifth prompt message corresponding to the fifth voice prompt “What special cuisine can I get in that area?” is seeking to engage a local search function, the fifth prompt message may be determined as a second type for processing by the generative AI system 300.

The fifth prompt message may then be processed by the generative AI model 310 (e.g., a machine-learned large language model). A digital message response may be generated by machine-learned large language model 310 and provided by the generative AI system 300 based on the fifth prompt message corresponding to the fifth voice prompt “What special cuisine can I get in that area?” In some examples, the digital message response may be converted to a speech-based voice response corresponding to “Carlsbad has a diverse food scene with plenty of options to choose from. If you're looking for special cuisines, you might want to check out Restaurant 1,which offers wood-fire dishes and craft cocktails. Another great option is Restaurant 2, which serves traditional Korean barbecue. If you're in the mood for seafood, Restaurant 3 is a great spot that offers fresh seafood dishes and has a great view of the ocean. Finally, if you're looking for a more upscale dining experience, Restaurant 4 is a great option that offers new American cuisine made with locally sourced ingredients. I hope that helps.” This voice response may be provided as audio output to the user 120 of the vehicle 105. In some examples, the digital message response may be converted to a graphical response corresponding to the different restaurants recommended near Carlsbad, California provided via a separate user interface (not illustrated).

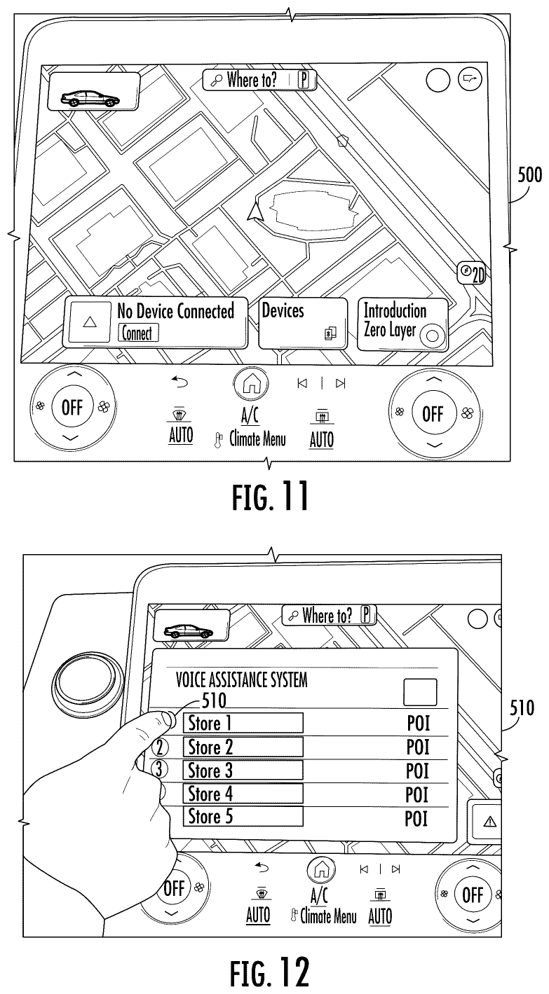

In a second example, FIGS. 11-17 illustrate content for presentation to the user 120 in response to various queries provided to a voice assistance system 195 according to example embodiments. For example, a digital message response (e.g., AI system response) may be presented as audio content for output via a speaker or visual content for output as various user interfaces 500-550 via display device 345 (e.g., onboard the vehicle 105). The user 120 may interact with the user interface (e.g., via one or more a user interface element) to select or accept information or options presented as part of the digital message response.

In the second example of FIGS. 11-17, a display device 345 may provide a user interface 500 in FIG. 11 that corresponds to a home screen for a voice assistance system 195 of a vehicle 102. The home screen depicted in user interface 500 may include map data of an environment surrounding vehicle 105, such as determined by positioning system 155 or navigation system 192 based on a current location of the vehicle 105.

A first voice prompt indicative of a speech-based voice query may be provided by a user 120 of the vehicle 105 while the home screen is displayed on user interface 500. In some examples, a triggering voice prompt that includes one or more particular trigger words or trigger phrases may be provided by a user 120 of the vehicle 105 to engage the voice assistance system 195 before a voice prompt indicative of a query may be provided. The voice assistance system 195 may be configured to regularly monitor user input to a vehicle microphone for speech-based content from the user 120 corresponding to the particular trigger words/phrases. Such monitoring may be controlled and turned-on/off by the user. Detection of a user providing a triggering voice prompt such as “Hey Mercedes” may initiate engagement of the voice assistance system 195.

In response to detection of the triggering voice prompt by the voice assistance system 195, an acknowledgement response may be provided as audio output or video output to the user 120 of the vehicle 105. For instance, an audio output such as “How can I help?” may be generated by voice assistance system 195 and provided to the user 120 of the vehicle 105. After hearing the acknowledgement response, a first voice prompt may be provided by the user 120 of the vehicle 105 corresponding to, “Where can I buy fancy shoes in San Francisco?” This particular voice prompt may seek to engage a local search function of the voice assistance system 195.

Based on the first voice prompt “Where can I buy fancy shoes in San Francisco”, the voice assistance system 195 may determine a first prompt message corresponding to a text-based transcription of the first voice prompt. The voice assistance system 195 or the user prompt processing system 200 may determine a type of the first prompt message as one of a first type for processing by a vehicle system onboard the vehicle 105 or a second type for processing by the generative AI system 300 (e.g., a machine-learned large language model). In this case, because the first prompt message corresponding to the first voice prompt “Where can I buy fancy shoes in San Francisco” is seeking to engage a local search function, the first prompt message may be determined as a second type for processing by the generative AI system 300.

The first prompt message may then be processed by the generative AI model 310 (e.g., a machine-learned large language model). A digital message response may be generated by generative AI model 310 and provided by the generative AI system 300 based on the first prompt message corresponding to the first voice prompt “Where can I buy fancy shoes in San Francisco?” In some examples, the digital message response may be converted to a speech-based voice response corresponding to “For fancy shoes, you may want to browse the stores in Union Square. There are many high end shoe stores in the area such as Shoe Store 1, Shoe Store 2, Shoe Store 3, Shoe Store 4, and Shoe Store 5.” The voice response may be provided as audio output to the user 120 of the vehicle 105. In some examples, the digital message response may be converted to a graphical response corresponding to the shoe store options in San Francisco, California provided via user interface 510 of FIG. 12.

Referring still to FIG. 12, user selection of a soft button 515 corresponding to Store 1 in user interface 510 may serve to engage navigation system 192 of the vehicle 105 to determine vehicle navigation instructions to the selected location of Store 1. A digital message response may be provided by the navigation system 192 based on the user selection of soft button 515. In some examples, the digital message response may be converted to a speech-based voice response corresponding to “Navigating to Store 1 located at 123 Main Street in San Francisco,” which is provided as audio output to the user 120 of the vehicle 105. In some examples, the digital message response may be converted to a graphical response corresponding to the navigation route and associated instructions provided via another user interface on display device 345.

Continuing with the second example of FIGS. 11-17, a second voice prompt indicative of a speech-based voice query may be provided by a user 120 of the vehicle 105 while a navigation route to Store 1 is displayed, a second voice prompt may be provided by the user 120 of the vehicle 105 corresponding to, “What's the weather like at my destination?” This particular voice prompt may seek to engage a weather function of the voice assistance system 195.

Based on the second voice prompt “What's the weather like at my destination?”, the voice assistance system 195 may determine a second prompt message corresponding to a text-based transcription of the second voice prompt. The voice assistance system 195 or the user prompt processing system 200 may determine a type of the second prompt message as one of a first type for processing by a vehicle system onboard the vehicle 105 or a second type for processing by the generative AI system 300 (e.g., a machine-learned large language model). In this case, because the second prompt message corresponding to the second voice prompt “What's the weather like at my destination?” is seeking to engage a weather function, the second prompt message may be determined as a second type for processing by the generative AI system 300.

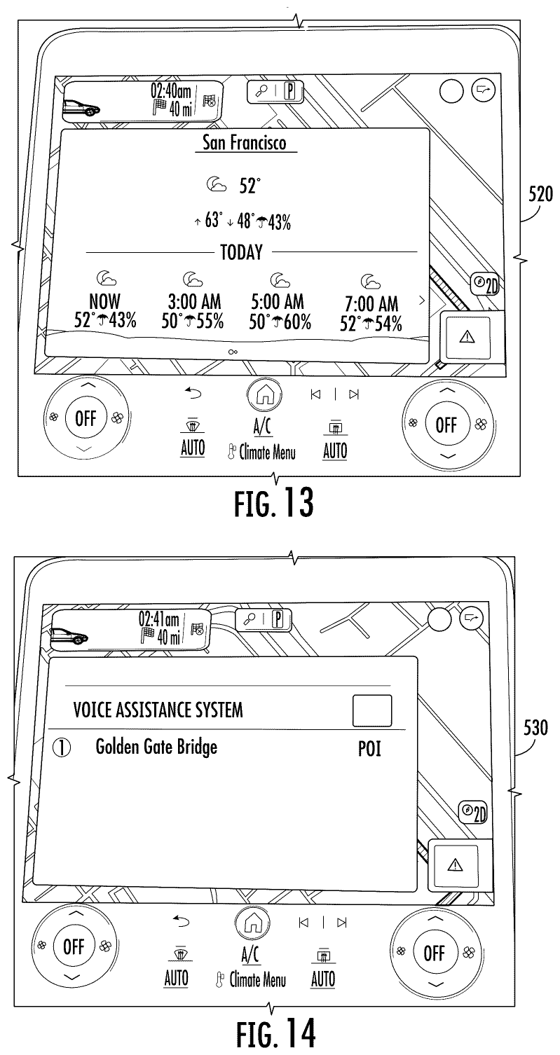

The second prompt message may then be processed by the generative AI model 310. A digital message response may be generated by the generative AI model 310 and provided by the generative AI system 300 based on the second prompt message corresponding to the second voice prompt “What's the weather like at my destination?” In some examples, the digital message response may be converted to a speech-based voice response corresponding to “The weather is 52 degrees and overcast in San Francisco, California” which is provided as audio output to the user 120 of the vehicle 105. In some examples, the digital message response may be converted to a graphical response corresponding to the weather forecast information for San Francisco, California provided via user interface 520 of FIG. 13.

Still further, a third voice prompt indicative of a speech-based voice query may be provided by a user 120 of the vehicle 105 while the weather forecast for San Francisco, California is displayed on user interface 520, a third voice prompt may be provided by the user 120 of the vehicle 105 corresponding to, “Can you tell me something interesting about San Francisco?” This particular voice prompt may seek to engage a conversational function of the voice assistance system 195.

Based on at least a portion of the third voice prompt “Can you tell me something interesting about San Francisco?”, the voice assistance system 195 may determine a third prompt message corresponding to a text-based transcription of the third voice prompt. The voice assistance system 195 or the user prompt processing system 200 may determine a type of the third prompt message as one of a first type for processing by a vehicle system onboard the vehicle 105 or a second type for processing by the generative AI system 300 (e.g., the machine-learned large language model). In this case, because the third prompt message corresponding to the third voice prompt “Can you tell me something interesting about San Francisco?” is seeking to engage a conversational function, the third prompt message may be determined as a second type for processing by the generative AI system 300.

The third prompt message may then be processed by the generative AI model 310 (e.g., a machine-learned large language model). A digital message response may be generated by the generative AI model 310 (e.g., a machine-learned large language model) and provided by the generative AI system 300 based on the third prompt message corresponding to the third voice prompt “Can you tell me something interesting about San Francisco?” In some examples, the digital message response may be converted to a speech-based voice response corresponding to “Sure. Did you know that the Golden Gate Bridge in San Francisco was almost a completely different color? The original plan was to make it black and yellow to make it more visible to passing ships, but the military's color preference did not come to fruition.” This voice response may be provided as audio output to the user 120 of the vehicle 105. In some examples, the digital message response may be converted to a graphical response corresponding to the point of interest discussed in the conversational response (e.g., the Golden Gate Bridge) provided via user interface 530 of FIG. 14.

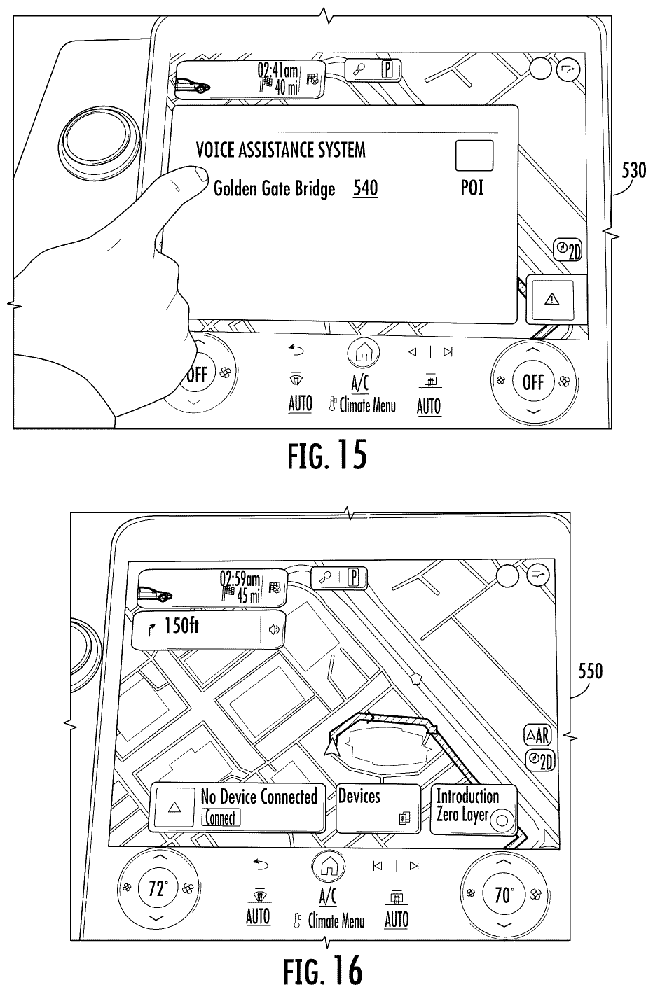

Continuing still with the second example of FIGS. 11-17, user touch input may be provided by a user 120 of the vehicle 105 while the point of interest option near San Francisco, California is displayed on the user interface 530 of FIG. 15. For example, as shown in FIG. 15, a finger of user 120 may be provided to select a soft button 540 on user interface 530 corresponding to the Golden Gate Bridge POI. Selection by user 120 of soft button 540 may serve to engage navigation system 192 of the vehicle 105 to determine vehicle navigation instructions to the selected location of Tamarack State Beach.

A digital message response may be provided by the navigation system 192 based on the user selection of soft button 540. In some examples, the digital message response may be converted to a speech-based voice response corresponding to “Navigating to Golden Gate Bridge,” which is provided as audio output to the user 120 of the vehicle 105. In some examples, the digital message response may be converted to a graphical response corresponding to the navigation route and associated instructions provided via another user interface on display device 345.

Still further, a fourth voice prompt indicative of a speech-based voice query may be provided by a user 120 of the vehicle 105 while route guidance to the Golden Gate State Bridge is displayed on a user interface. For example, a fourth voice prompt may be provided by the user 120 of the vehicle 105 corresponding to, “Turn on the Fan.” This particular voice prompt may seek to engage a climate function of the voice assistance system 195.

Based on the fourth voice prompt “Turn on the Fan,” the voice assistance system 195 may determine a fourth prompt message corresponding to a text-based transcription of the fourth voice prompt. The voice assistance system 195 or the user prompt processing system 200 may determine a type of the fourth prompt message as one of a first type for processing by a vehicle system onboard the vehicle 105 or a second type for processing by the generative AI system 300 (e.g., the machine-learned large language model). In this case, because the fourth prompt message corresponding to the fourth voice prompt “Turn on the fan” is seeking to engage a climate function, the fourth prompt message may be determined as a first type for processing by a vehicle system onboard the vehicle 105.

The fourth prompt message may then be processed by the computing system 130 onboard the vehicle 105. A digital message response may be provided by the computing system 130 based on the fourth prompt message corresponding to the fourth voice prompt “Turn on the fan.” In some examples, the digital message response may be converted to a speech-based voice response corresponding to “I′m switching on the ventilation,” which is provided as audio output to the user 120 of the vehicle 105. In some examples, the digital message response may be converted to a graphical response corresponding to a climate setting (e.g., a fan status or fan speed) provided via a user interface on display device 345.

A fifth voice prompt indicative of a speech-based voice query may be provided by a user 120 of the vehicle 105 after the request to “Turn on the fan.” For example, a fifth voice prompt may be provided by the user 120 of the vehicle 105 corresponding to, “Increase the temperature.” Similar to the fourth voice prompt, this particular voice prompt may also seek to engage a climate function of the voice assistance system 195.

Based on the fifth voice prompt “Increase the temperature,” the voice assistance system 195 may determine a fifth prompt message corresponding to a text-based transcription of the fourth voice prompt. The voice assistance system 195 or the user prompt processing system 200 may determine a type of the fifth prompt message as one of a first type for processing by a vehicle system onboard the vehicle 105 or a second type for processing by the generative AI system 300 (e.g., the machine-learned large language model). In this case, because the fifth prompt message corresponding to the fifth voice prompt “Increase the temperature” is seeking to engage a climate function, the fifth prompt message may be determined as a first type for processing by a vehicle system onboard the vehicle 105.

The fifth prompt message may then be processed by the computing system 130 onboard the vehicle 105. A digital message response may be provided by the computing system 130 based on the fifth prompt message corresponding to the fifth voice prompt “Increase the temperature.” In some examples, the digital message response may be converted to a speech-based voice response corresponding to “I'm increasing the temperature to 72,” which is provided as audio output to the user 120 of the vehicle 105. In some examples, the digital message response may be converted to a graphical response corresponding to a climate setting (e.g., a temperature setting) provided via user interface 550 of FIG. 16.

Finally, a sixth voice prompt indicative of a speech-based voice query may be provided by a user 120 of the vehicle 105 while the vehicle 105 continues to navigate to the Golden Gate Bridge. A sixth voice prompt may be provided by the user 120 of the vehicle 105 corresponding to, “Find Italian restaurants in San Francisco.” This particular voice prompt may seek to engage a local search function of the voice assistance system 195.

Based on the sixth voice prompt “Find Italian restaurants in San Francisco,” the voice assistance system 195 may determine a sixth prompt message corresponding to a text-based transcription of the sixth voice prompt. The voice assistance system 195 or the user prompt processing system 200 may determine a type of the sixth prompt message as one of a first type for processing by a vehicle system onboard the vehicle 105 or a second type for processing by the generative AI system 300 (e.g., the machine-learned large language model). In this case, because the sixth prompt message corresponding to the sixth voice prompt “Find Italian restaurants in San Francisco” is seeking to engage a local search function, the sixth prompt message may be determined as a second type for processing by the generative AI system 300.

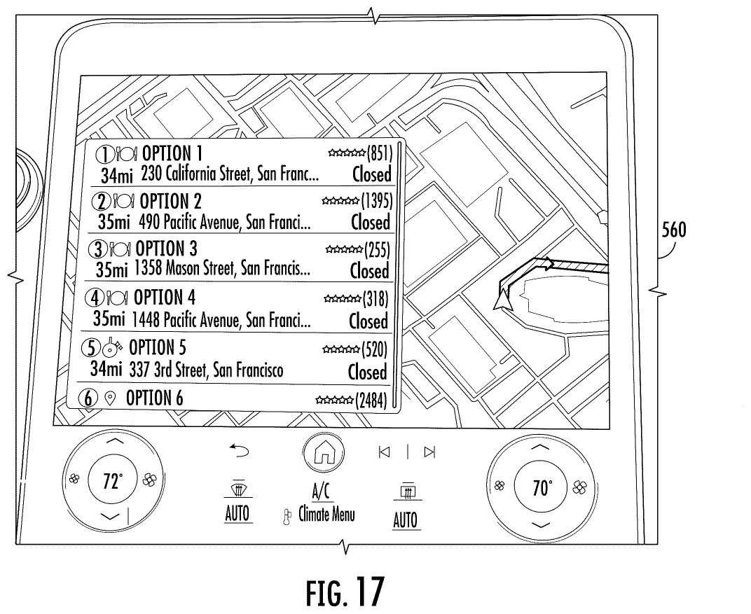

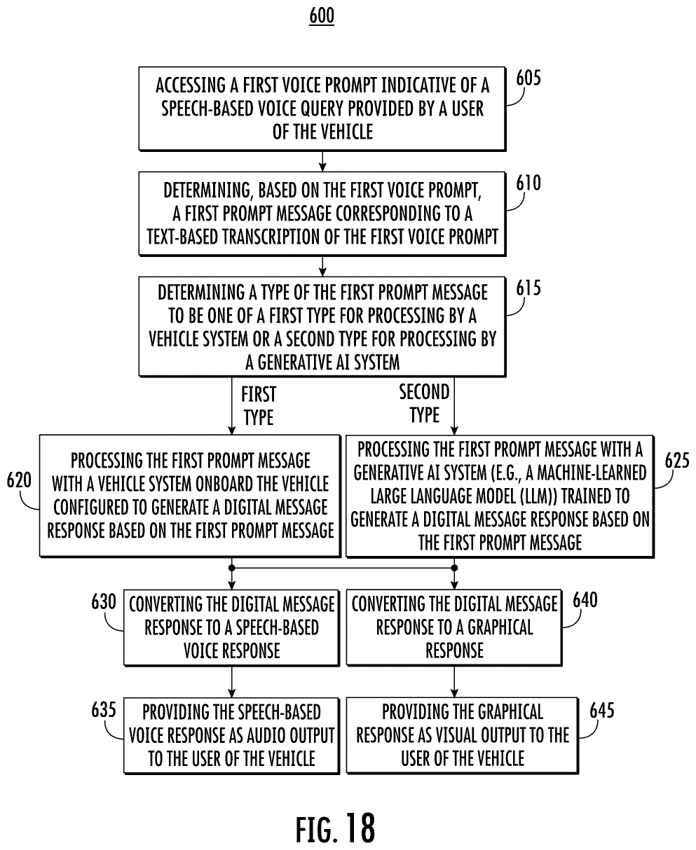

The sixth prompt message may then be processed by the generative AI model 310. A digital message response may be generated by the generative AI model 310 (e.g., a machine-learned large language model) and provided by the generative AI system 300 based on the sixth prompt message corresponding to the sixth voice prompt “Find Italian restaurants in San Francisco.” In some examples, the digital message response may be converted to a speech-based voice response corresponding to “Here is what I found. Where do you want to go?” This voice response may be provided as audio output to the user 120 of the vehicle 105. In some examples, the digital message response may be converted to a graphical response corresponding to a list of selectable Italian restaurants recommended near San Francisco, California, such as provided via user interface 560 of FIG. 17.

In some examples, user 120 may respond with an additional voice prompt requesting selection of “Option 2.” In other examples, user 120 may respond instead of by voice with touch selection of a soft button corresponding to Italian restaurant “Option 2” in the user interface 560 of FIG. 17. Selection of Option 2 may serve to engage navigation system 192 of the vehicle 105 to determine vehicle navigation instructions to the selected location of the second listed Italian restaurant. A digital message response may be provided by the navigation system 192 based on the user selection of Option 2. In some examples, the digital message response may be converted to a speech-based voice response corresponding to “I have set the intermediate destination to Restaurant 2. The route is being calculated,” which is provided as audio output to the user 120 of the vehicle 105. In some examples, the digital message response may be converted to a graphical response corresponding to the navigation route and associated instructions provided via another user interface on display device 345.

FIG. 18 illustrates a flowchart diagram of an example method 600 for providing voice assistance for a user of a vehicle according to an embodiment hereof. The method 600 may be performed by a computing system described with reference to the other figures. In an embodiment, the method 600 may be performed by the control circuit 135 of the computing system 130 or computing platform 110 of FIG. 1. One or more portions of the method 600 may be implemented as an algorithm on the hardware components of the devices described herein (e.g., as in FIGS. 1-4 and 20, etc.). For example, the steps of method 600 may be implemented as operations/instructions that are executable by computing hardware.

FIG. 18 illustrates elements performed in a particular order for purposes of illustration and discussion. Those of ordinary skill in the art, using the disclosures provided herein, will understand that the elements of any of the methods discussed herein may be adapted, rearranged, expanded, omitted, combined, or modified in various ways without deviating from the scope of the present disclosure. FIG. 18 is described with reference to elements/terms described with respect to other systems and figures for example illustrated purposes and is not meant to be limiting. One or more portions of method 600 may be performed additionally, or alternatively, by other systems. For example, method 600 may be performed by a control circuit 185 of the computing platform 110.

In an example embodiment, the method 600 may begin with or otherwise include a step 605, in which the voice assistance system 195 of computing system 130 receives or otherwise accesses a first voice prompt indicative of a speech-based voice query provided by a user 120 of the vehicle 105. The first voice prompt accessed at step 605 may be received by a microphone or other sound sensor provided within an interior of vehicle 105.

In an example embodiment, the method 600 may also include a step 610, in which the voice assistance system 195 of computing system 130 determines, based on the first voice prompt accessed at step 605, a first prompt message corresponding to a text-based transcription of the first voice prompt. In an embodiment, the first prompt message determined at step 610 may correspond to one or more of a full transcription, a partial transcription, or a modified transcription of the first voice prompt accessed at step 605.

In some example embodiments, determining the first prompt message at step 610 may be implemented by the voice assistance system 195, which may include one or more processors that are configured to perform a transcription, speech recognition, or speech-to-text function. In some implementations, the transcription, speech recognition, or speech-to-text function may be performed on the user prompt processing system 200 (e.g., based on audio data captured by the one or more microphones). As mentioned above, the user prompt processing system 200 may be a cloud-based platform that supports the voice assistance system 195 with additional processing power/capabilities. If the first prompt message is determined at step 610 by the voice assistance system 195 on the vehicle 105, then the user prompt processing system 200 may be omitted, or may receive the first prompt message determined at step 610 from the voice assistance system 195 and may determine whether the first prompt message needs to be modified (e.g., to add context information). In some examples, determining the first prompt message at step 610 corresponding to a text-based transcription of the first voice prompt accessed at step 605 is implemented by a prompt processing system having been trained using terminology from a user guide specific to the vehicle 105.

In an embodiment, the method 600 may also include a step 615, in which the voice assistance system 195 of the computing system 130 determines a type of the first prompt message determined at step 610 as one of a first type for processing by a vehicle system onboard the vehicle 105 or a second type for processing by the generative AI system 300 (e.g., by a machine-learned large language model).

In response to determining at step 615 the first prompt message to be the first type for processing by a vehicle system, the method 600 may also include a step 620 in which the vehicle system (e.g., a navigation system 192, a climate control function corresponding to one of control functions 165A-165C, or voice assistance system 195) onboard the vehicle 105 processes the first prompt message. An example of a first type of prompt message determined at step 615 is a prompt message corresponding to a climate control function or a navigation function. This type of prompt message may, thus, be processed by an onboard system/function other than one utilizing an machine-learned large language model.

In response to determining at step 615 the first prompt message to be the second type for processing by the generative AI system 300 (e.g., by a machine-learned large language model), the method 600 may also include a step 625 in which the generative AI model 310 processes the first prompt message. An example of a second type of prompt message determined at step 615 is a prompt message corresponding to a local search function, a weather function, an entity recognition function, or a conversational function. The machine-learned large language model 310 configured to process the first prompt message at step 625 may be trained to generate a first digital message response based on the first prompt message. In some instances, the generative AI system 300 configured to process the first prompt message at step 625 may be an LLM system, and the generative AI model may be a LLM model (e.g., a generative pre-trained transformer model).

In some examples, the generative AI system 300 receives not only the first prompt message, but a predetermined number of recent prompt messages (e.g., the last two, three, four, or five voice queries or prompt messages) for additional context. In this way, if a voice prompt requests local search associated with a particular geographic region identified in a previous query, the generative AI system 300 has access to recent queries that would have identified the particular geographic region. Accordingly, the LLM system generates a response at step 625 (referred to herein as an AI system response or digital message response) based on the first prompt message.

In an example embodiment, the method 600 may also include a step 630 in which the user prompt processing system 200 or voice assistance system 195 may receive the digital message response determined at step 620 or step 625 and convert the digital message response to a speech-based voice response for the user 120 of the vehicle 105. The speech-based voice response may be generated at step 630 via a speech synthesis function that converts the digital message response to a voice response. In some instances, the speech synthesis function may generate an audio file or audio stream, and may be performed on the user prompt processing system 200 or the voice assistance system 195.

In an example embodiment, the method 600 may also include a step 635 in which the voice assistance system 195 provides the speech-based voice response generated at step 630 as audio output to the user 120 of the vehicle 105. In some instances, the audio output is provided to a user 120 at step 635 via one or more speakers configured to play the audio file or audio stream generated at step 630.

In an example embodiment, the method 600 may additionally or alternatively to steps 630 and 635 include steps 640 and 645. More particularly, at step 640, the user prompt processing system 200 or the voice assistance system 195 may receive the digital message response determined at step 620 or step 625 and convert the digital message response to a graphical response for the user 120 of the vehicle 105. The graphical response may be generated via an image processing function that converts the digital message response to a graphical response. In some instances, the image processing function may generate an image or video file, and may be performed on the user prompt processing system 200 or the voice assistance system 195.

In an example embodiment, the method 600 may also include a step 645 in which the voice assistance system 195 provides the graphical response generated at step 640 as visual output to the user 120 of the vehicle 105. In some instances, the visual output is provided to a user 120 at step 645 via one or more touchscreens or other display devices to provide the graphical response as visual output to the user 120 of the vehicle 105.

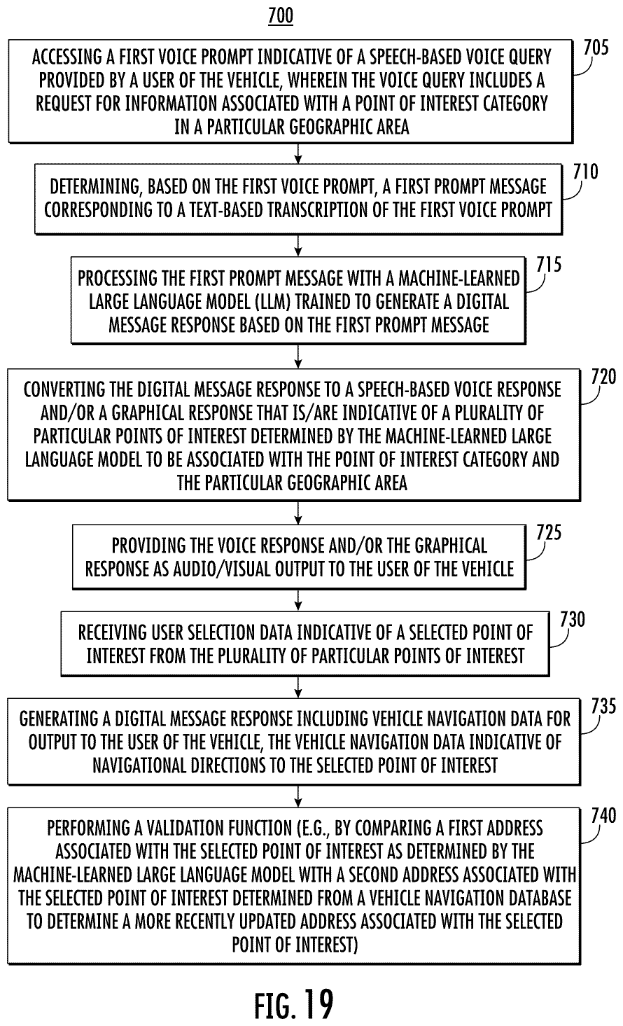

FIG. 19 illustrates a flowchart diagram of an example method 700 for providing voice assistance for a user of a vehicle according to an embodiment hereof. The method 700 may be performed by a computing system described with reference to the other figures. In an embodiment, the method 700 may be performed by the control circuit 135 of the computing system 130 or computing platform 110 of FIG. 1. One or more portions of the method 700 may be implemented as an algorithm on the hardware components of the devices described herein (e.g., as in FIGS. 1-4 and 20, etc.). For example, the steps of method 700 may be implemented as operations/instructions that are executable by computing hardware. One or more portions of the method 700 of FIG. 19 may be integrated into the method 600 of FIG. 18 and vice versa.

FIG. 19 illustrates elements performed in a particular order for purposes of illustration and discussion. Those of ordinary skill in the art, using the disclosures provided herein, will understand that the elements of any of the methods discussed herein may be adapted, rearranged, expanded, omitted, combined, or modified in various ways without deviating from the scope of the present disclosure. FIG. 19 is described with reference to elements/terms described with respect to other systems and figures for example illustrated purposes and is not meant to be limiting. One or more portions of method 700 may be performed additionally, or alternatively, by other systems. For example, method 700 may be performed by a control circuit 185 of the computing platform 110.

In an example embodiment, the method 700 may begin with or otherwise include a step 705, in which the voice assistance system 195 of computing system 130 receives or otherwise accesses a first voice prompt indicative of a speech-based voice query provided by a user 120 of the vehicle 105. The first voice prompt accessed at step 705 may be received by a microphone or other sound sensor provided within an interior of vehicle 105. The first voice prompt accessed at step 705 may be seeking to engage a local search function of the voice assistance system 195. For example, the first voice prompt accessed at step 705 may include a request for information associated with a point of interest category (e.g., restaurant, beach, hotel, museum, store, etc.) in a particular geographic area (e.g., town, city, municipality, county, zip code, etc.)

In an example embodiment, the method 700 may include a step 710, in which the voice assistance system 195 of computing system 130 determines, based on the first voice prompt accessed at step 705, a first prompt message corresponding to a text-based transcription of the first voice prompt. In an embodiment, the first prompt message determined at step 710 may correspond to one or more of a full transcription, a partial transcription, or a modified transcription of the first voice prompt accessed at step 705. Additional aspects of determining a first prompt message at 710 may be similar to step 610 described with reference to FIG. 18.

In an example embodiment, the method 700 may include a step 715, in which a generative AI system 300 (e.g., via machine-learned large language model trained to generate a digital message response based on the first prompt message) may be used to process the first prompt message determined at step 710. The machine-learned large language model configured to process the first prompt message at step 715 may be trained to generate a first digital message response based on the first prompt message. In some instances, the generative AI system 300 configured to process the first prompt message at step 715 may be a LLM system, and the generative AI model 310 may be a large language model (e.g., a generative pre-trained transformer model such). Accordingly, the system generates a response at step 715 (referred to herein as an AI system response or digital message response) based on the first prompt message.

In an example embodiment, the method 700 may include a step 720, in which voice assistance system 195 is configured to convert the digital message response generated by the large language model at step 715 to a speech-based voice response or a graphical response. Such response determined at step 720 is indicative of a plurality of particular points of interest determined by the machine-learned large language model to be associated with the point of interest category and the particular geographic area specified in the first voice prompt (or recent user prompts relayed with the first voice prompt).

In an example embodiment, the method 700 may include a step 725 of providing the voice response or the graphical response determined at step 720 as audio/visual output to the user 120 of the vehicle 105. In some instances, the audio output is provided to a user 120 at step 725 via one or more speakers configured to play an audio file or audio stream. In some instances, the visual output may include an image or video file that is presented graphically to a user 120 of the vehicle 105 via display device 345.

In an example embodiment, the method 700 may include a step 730 of receiving user selection data indicative of a selected point of interest from the plurality of particular points of interest identified at step 720. User selection may be initiated by voice command received by a microphone of the vehicle 105, by touch selection of a soft button on a user interface provided by a display device of the vehicle 105, or other input component of vehicle 105.

In an example embodiment, the method 700 may include a step 735 of generating a digital message response including vehicle navigation data for output to the user of the vehicle. The vehicle navigation data generated at step 735 may be indicative of navigational directions to the selected point of interest (e.g., the point of interest selected by the user 120 at step 730). The vehicle navigation data generated at step 735 may be determined, for example, by navigation system 192 of vehicle 105.

In an example embodiment, the method 700 may include a step 740 of performing a validation function to the digital message response generated at step 735 before providing the speech-based voice response or graphical response as audio/visual output to the user of the vehicle. One example validation function may include comparing a first address associated with the selected point of interest (e.g., the point of interest selected at step 730) as determined by the machine-learned large language model with a second address associated with the selected point of interest determined from a vehicle navigation database (e.g., a database associated with navigation system 192) to determine a more recently updated address associated with the selected point of interest. In this way, a validation check can happen to better ensure that the most up-to-date and accurate navigation instructions are ultimately provided to a user 120 of the vehicle 105.

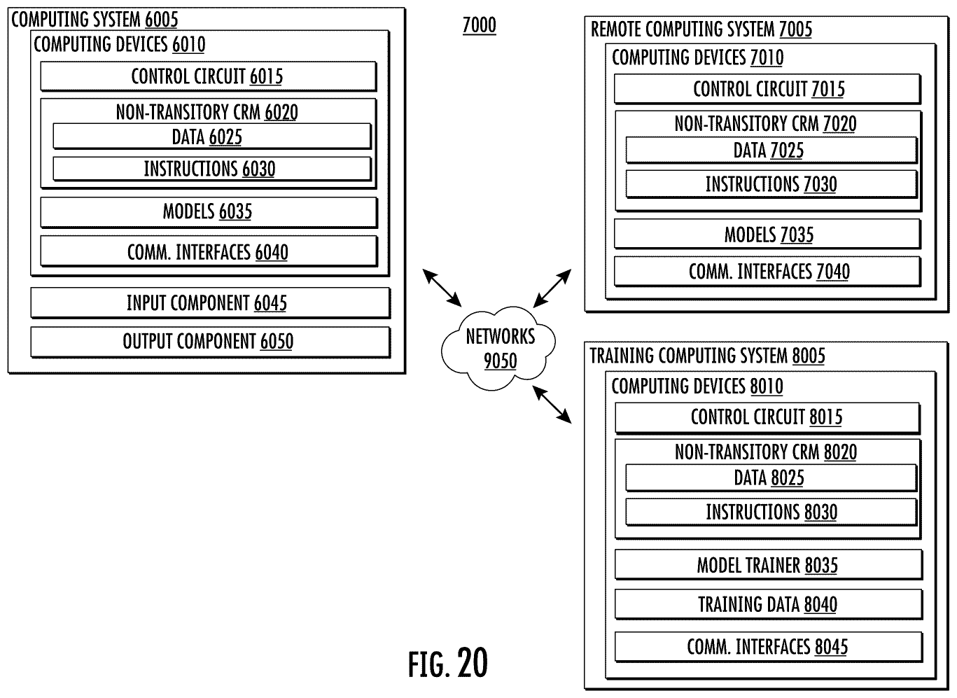

FIG. 20 illustrates a block diagram of an example computing system 7000 according to an embodiment hereof. The system 7000 includes a computing system 6005, a remote computing system 7005, and a training computing system 8005 that are communicatively coupled over one or more networks 9050.

The computing system 6005 may include one or more computing devices 6010 or circuitry. For instance, the computing system 6005 may include a control circuit 6015 and a non-transitory computer-readable medium 6020, also referred to herein as memory. In an embodiment, the control circuit 6015 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In some implementations, the control circuit 6015 may be part of, or may form, a vehicle control unit (also referred to as a vehicle controller) that is embedded or otherwise disposed in a vehicle (e.g., a Mercedes-Benz® car or van). For example, the vehicle controller may be or may include an infotainment system controller (e.g., an infotainment head-unit), a telematics control unit (TCU), an electronic control unit (ECU), a central powertrain controller (CPC), a charging controller, a central exterior & interior controller (CEIC), a zone controller, or any other controller. In an embodiment, the control circuit 6015 may be programmed by one or more computer-readable or computer-executable instructions stored on the non-transitory computer-readable medium 6020.

In an embodiment, the non-transitory computer-readable medium 6020 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium 6020 may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), or a memory stick.

The non-transitory computer-readable medium 6020 may store information that may be accessed by the control circuit 6015. For instance, the non-transitory computer-readable medium 6020 (e.g., memory devices) may store data 6025 that may be obtained, received, accessed, written, manipulated, created, or stored. The data 6025 may include, for instance, any of the data or information described herein. In some implementations, the computing system 6005 may obtain data from one or more memories that are remote from the computing system 6005.

The non-transitory computer-readable medium 6020 may also store computer-readable instructions 6030 that may be executed by the control circuit 6015. The instructions 6030 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 6015 to perform one or more functional tasks. The modules and computer-readable/executable instructions may be described as performing various operations or tasks when the control circuit 6015 or other hardware component is executing the modules or computer-readable instructions.

The instructions 6030 may be executed in logically or virtually separate threads on the control circuit 6015. For example, the non-transitory computer-readable medium 6020 may store instructions 6030 that when executed by the control circuit 6015 cause the control circuit 6015 to perform any of the operations, methods or processes described herein. In some cases, the non-transitory computer-readable medium 6020 may store computer-executable instructions or computer-readable instructions, such as instructions to perform at least a portion of the methods of FIGS. 18-19.

In an embodiment, the computing system 6005 may store or include one or more machine-learned models 6035. For example, the machine-learned models 6035 may be or may otherwise include various machine-learned models for use in the computing system 130, cloud-based computing platform 110, voice assistance system 195, user prompt processing system 200, or generative AI system 300 disclosed herein. Machine-learned models 6035 may include the generative AI model 310 (e.g., a machine-learned large language model). In an embodiment, the machine-learned models 6035 may include neural-based models (e.g., MLP (multi-layer perceptron), etc.). In an embodiment, the machine-learned models 6035 may include neural networks (e.g., deep neural networks) or other types of machine-learned models, including non-linear models or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models). As another example, the machine-learned models 6035 can include generative models, such as stable diffusion models, generative adversarial networks (GAN), GPT models, and other suitable models.

In an aspect of the present disclosure, the models 6035 may be used to provide voice assistance to a user 120 of a vehicle 105. For example, the machine-learned models 6035 can, in response to voice prompts from a user, generate tailored natural language responses and generate audio or visual output for presentation to a user.

In an embodiment, the one or more machine-learned models 6035 may be received from the remote computing system 7005 over networks 9050, stored in the computing system 6005 (e.g., non-transitory computer-readable medium 6020), and then used or otherwise implemented by the control circuit 6015. In an embodiment, the computing system 6005 may implement multiple parallel instances of a single model.

Additionally, or alternatively, one or more machine-learned models 6035 may be included in or otherwise stored and implemented by the remote computing system 7005 that communicates with the computing system 6005 according to a client-server relationship. For example, the machine-learned models 6035 may be implemented by the remote computing system 7005 as a portion of a web service. Thus, one or more models 6035 may be stored or implemented (e.g., as models 7035) at the computing system 6005 or one or more models 6035 may be stored and implemented at the remote computing system 7005.

The computing system 6005 may include one or more communication interfaces 6040. The communication interfaces 6040 may be used to communicate with one or more other systems. The communication interfaces 6040 may include any circuits, components, software, etc. for communicating via one or more networks (e.g., networks 9050). In some implementations, the communication interfaces 6040 may include for example, one or more of a communications controller, receiver, transceiver, transmitter, port, conductors, software or hardware for communicating data/information.

The computing system 6005 may also include one or more user input components 6045 that receives user input. For example, the user input component 6045 may be a touch-sensitive component (e.g., a touch-sensitive display screen or a touch pad) that is sensitive to the touch of a user input object (e.g., a finger or a stylus). The touch-sensitive component may serve to implement a virtual keyboard. Other example user input components include a microphone, a traditional keyboard, cursor-device, joystick, or other devices by which a user may provide user input.

The computing system 6005 may include one or more output components 6050. The output components 6050 may include hardware or software for audibly or visually producing content. For instance, the output components 6050 may include one or more speakers, carpieces, headsets, handsets, etc. The output components 6050 may include a display device, which may include hardware for displaying a user interface or messages for a user. By way of example, the output component 6050 may include a speaker, display screen, CRT, LCD, plasma screen, touch screen, TV, projector, tablet, or other suitable display components.

The remote computing system 7005 may include one or more computing devices 7010. In an embodiment, the remote computing system 7005 may include or is otherwise implemented by one or more computing devices onboard an autonomous drone. In instances in which the remote computing system 7005 includes computing devices onboard an autonomous drone, such computing devices may operate according to sequential computing architectures, parallel computing architectures, or some combination thereof.

The remote computing system 7005 may include a control circuit 7015 and a non-transitory computer-readable medium 7020, also referred to herein as memory 7020. In an embodiment, the control circuit 7015 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 7015 may be programmed by one or more computer-readable or computer-executable instructions stored on the non-transitory computer-readable medium 7020.

In an embodiment, the non-transitory computer-readable medium 7020 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), or a memory stick.

The non-transitory computer-readable medium 7020 may store information that may be accessed by the control circuit 7015. For instance, the non-transitory computer-readable medium 7020 (e.g., memory devices) may store data 7025 that may be obtained, received, accessed, written, manipulated, created, or stored. The data 7025 may include, for instance, any of the data or information described herein. In some implementations, the server system 7005 may obtain data from one or more memories that are remote from the server system 7005.

The non-transitory computer-readable medium 7020 may also store computer-readable instructions 7030 that may be executed by the control circuit 7015. The instructions 7030 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 7015 to perform one or more functional tasks. The modules and computer-readable/executable instructions may be described as performing various operations or tasks when the control circuit 7015 or other hardware component is executing the modules or computer-readable instructions.

The instructions 7030 may be executed in logically or virtually separate threads on the control circuit 7015. For example, the non-transitory computer-readable medium 7020 may store instructions 7030 that when executed by the control circuit 7015 cause the control circuit 7015 to perform any of the operations, methods or processes described herein. In some cases, the non-transitory computer-readable medium 7020 may store computer-executable instructions or computer-readable instructions, such as instructions to perform at least a portion of the methods of FIG. 18-19.

The remote computing system 7005 may include one or more communication interfaces 7040. The communication interfaces 7040 may be used to communicate with one or more other systems. The communication interfaces 7040 may include any circuits, components, software, etc. for communicating via one or more networks (e.g., networks 9050). In some implementations, the communication interfaces 7040 may include for example, one or more of a communications controller, receiver, transceiver, transmitter, port, conductors, software or hardware for communicating data/information.

The computing system 6005 or the remote computing system 7005 may train the models 6035, 7035 via interaction with the training computing system 8005 that is communicatively coupled over the networks 9050. The training computing system 8005 may be separate from the remote computing system 7005 or may be a portion of the remote computing system 7005.

The training computing system 8005 may include one or more computing devices 8010. In an embodiment, the training computing system 8005 may include or is otherwise implemented by one or more server computing devices. In instances in which the training computing system 8005 includes plural server computing devices, such server computing devices may operate according to sequential computing architectures, parallel computing architectures, or some combination thereof.

The training computing system 8005 may include a control circuit 8015 and a non-transitory computer-readable medium 8020, also referred to herein as memory 8020. In an embodiment, the control circuit 8015 may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), or any other control circuit. In an embodiment, the control circuit 8015 may be programmed by one or more computer-readable or computer-executable instructions stored on the non-transitory computer-readable medium 8020.

In an embodiment, the non-transitory computer-readable medium 8020 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, e.g., a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), or a memory stick.

The non-transitory computer-readable medium 8020 may store information that may be accessed by the control circuit 8015. For instance, the non-transitory computer-readable medium 8020 (e.g., memory devices) may store data 8025 that may be obtained, received, accessed, written, manipulated, created, or stored. The data 8025 may include, for instance, any of the data or information described herein. In some implementations, the training computing system 8005 may obtain data from one or more memories that are remote from the training computing system 8005.

The non-transitory computer-readable medium 8020 may also store computer-readable instructions 8030 that may be executed by the control circuit 8015. The instructions 8030 may be software written in any suitable programming language or may be implemented in hardware. The instructions may include computer-readable instructions, computer-executable instructions, etc. As described herein, in various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 8015 to perform one or more functional tasks. The modules and computer-readable/executable instructions may be described as performing various operations or tasks when the control circuit 8015 or other hardware component is executing the modules or computer-readable instructions.

The instructions 8030 may be executed in logically or virtually separate threads on the control circuit 8015. For example, the non-transitory computer-readable medium 8020 may store instructions 8030 that when executed by the control circuit 8015 cause the control circuit 8015 to perform any of the operations, methods or processes described herein. In some cases, the non-transitory computer-readable medium 8020 may store computer-executable instructions or computer-readable instructions, such as instructions to perform at least a portion of the methods of FIG. 18-19.

The training computing system 8005 may include a model trainer 8035 that trains the machine-learned models 6035, 7035 stored at the computing system 6005 or the remote computing system 7005 using various training or learning techniques. For example, the models 6035, 7035 (e.g., a machine-learned model) may be trained using a loss function that evaluates quality of generated samples over various characteristics, such as similarity to the training data.

The training computing system 8005 may modify parameters of the models 6035, 7035 (e.g., the machine-learned model) based on the loss function (e.g., generative loss function) such that the models 6035, 7035 may be effectively trained for specific applications in a supervised manner using labeled data or in an unsupervised manner.

In an example, the model trainer 8035 may backpropagate the loss function through the models 6035, 7035 (e.g., the machine-learned model) to modify the parameters (e.g., weights) of the models 6035, 7035. The model trainer 8035 may continue to backpropagate the loss function through the machine-learned model, with or without modification of the parameters (e.g., weights) of the model. For instance, the model trainer 8035 may perform a gradient descent technique in which parameters of the machine-learned model may be modified in the direction of a negative gradient of the loss function. Thus, in an embodiment, the model trainer 8035 may modify parameters of the machine-learned model based on the loss function.

The model trainer 8035 may utilize training techniques, such as backwards propagation of errors. For example, a loss function may be backpropagated through a model to update one or more parameters of the models (e.g., based on a gradient of the loss function). Various loss functions may be used such as mean squared error, likelihood loss, cross entropy loss, hinge loss, or various other loss functions. Gradient descent techniques may be used to iteratively update the parameters over a number of training iterations.

In an embodiment, performing backwards propagation of errors may include performing truncated backpropagation through time. The model trainer 8035 may perform a number of generalization techniques (e.g., weight decays, dropouts, etc.) to improve the generalization capability of a model being trained. In particular, the model trainer 8035 may train the machine-learned models 6035, 7035 based on a set of training data 8040.

The training data 8040 may include unlabeled training data for training in an unsupervised fashion. Furthermore, in some implementations, the training data 8040 can include labeled training data for training in a supervised fashion. Training data 8040 can be or can include language samples that include terminology from a user guide specific to the vehicle 105. By training with vehicle-specific terminology, determination of vehicle functions requested by the voice assistance system 195 can be better realized in a more accurate manner.

In an embodiment, if the user has provided consent/authorization, training examples may be provided by the computing system 6005 (e.g., of the user's vehicle). Thus, in such implementations, a model 6035 provided to the computing system 6005 may be trained by the training computing system 8005 in a manner to personalize the model 6035.

The model trainer 8035 may include computer logic utilized to provide desired functionality. The model trainer 8035 may be implemented in hardware, firmware, or software controlling a general-purpose processor. For example, in an embodiment, the model trainer 8035 may include program files stored on a storage device, loaded into a memory and executed by one or more processors. In other implementations, the model trainer 8035 may include one or more sets of computer-executable instructions that are stored in a tangible computer-readable storage medium such as RAM, hard disk, or optical or magnetic media.

The training computing system 8005 may include one or more communication interfaces 8045. The communication interfaces 8045 may be used to communicate with one or more other systems. The communication interfaces 8045 may include any circuits, components, software, etc. for communicating via one or more networks (e.g., networks 9050). In some implementations, the communication interfaces 8045 may include for example, one or more of a communications controller, receiver, transceiver, transmitter, port, conductors, software or hardware for communicating data/information.

### ADDITIONAL DISCUSSION OF VARIOUS EMBODIMENTS

Embodiment 1 relates to a computing system for a vehicle. In this embodiment, the computing system comprises one or more processors and one or more tangible, non-transitory, computer readable media storing instructions for execution by the one or more processors to cause the computing system to perform operations comprising the following: accessing a first voice prompt indicative of a speech-based voice query provided by a user of the vehicle; determining, based on the first voice prompt, a first prompt message corresponding to a text-based transcription of the first voice prompt; processing the first prompt message with a machine-learned large language model trained to generate a digital message response based on the first prompt message; converting the digital message response to a speech-based voice response; and providing the speech-based voice response as audio output to the user of the vehicle.

Embodiment 2 includes the computing system for a vehicle of Embodiment 1. In this embodiment, the operations further comprises: converting the digital message response to a graphical response; and providing the graphical response as visual output to the user of the vehicle in conjunction with providing the speech-based voice response as audio output to the user of the vehicle.

Embodiment 3 includes the computing system for a vehicle of embodiment 1 or 2. In his embodiment, the speech-based voice query provided by a user of the vehicle comprises a request for information associated with a point of interest category in a particular geographic area; and the speech-based voice response is indicative of a plurality of particular points of interest determined by the machine-learned large language model to be associated with the point of interest category and the particular geographic area.

Embodiment 4 includes the computing system for a vehicle of any one of embodiments 1-3. In this embodiment, the operations further comprises: receiving user selection data indicative of a selected point of interest from the plurality of particular points of interest; and generating vehicle navigation data as an output to the user of the vehicle, the vehicle navigation data indicative of navigational directions to the selected point of interest.

Embodiment 5 includes the computing system for a vehicle of any one of embodiments 1-4. In this embodiment, the operations further comprises: comparing a first address associated with the selected point of interest as determined by the machine-learned large language model with a second address associated with the selected point of interest determined from a vehicle navigation database to determine a more recently updated address associated with the selected point of interest; and providing vehicle navigation data associated with the more recently updated address associated with the selected point of interest as the output to the user of the vehicle.

Embodiment 6 includes the computing system for a vehicle of any one of embodiments 1-5. In this embodiment, the operations further comprising: determining a type of the first prompt message as one of a first type for processing by a vehicle system onboard the vehicle or a second type for processing by the machine-learned large language model; and processing the first prompt message with the machine-learned large language model in response to determining the first prompt message to be the second type for processing by the machine-learned large language model.

Embodiment 7 includes the computing system for a vehicle of any one of embodiments 1-6. In this embodiment, the operations further comprises: performing a validation function to the digital message response before providing the speech-based voice response as audio output to the user of the vehicle.

Embodiment 8 includes the computing system for a vehicle of any one of embodiments 1-7. In this embodiment, determining the first prompt message corresponding to a text-based transcription of the first voice prompt is implemented by a prompt processing system having been trained using terminology from a user guide specific to the vehicle.

Embodiment 9 includes the computing system for a vehicle of any one of embodiments 1-8. In this embodiment, the first prompt message corresponds to one or more of a full transcription, a partial transcription, or a modified transcription of the first voice prompt.

Embodiment 10 includes the computing system for a vehicle of any one of embodiments 1-9. In this embodiment, the machine-learned large language model comprises a generative pre-trained transformer model.

### Additional Disclosure

As used herein, adjectives and their possessive forms are intended to be used interchangeably unless apparent otherwise from the context or expressly indicated. For instance, “component of a/the vehicle” may be used interchangeably with “vehicle component” where appropriate. Similarly, words, phrases, and other disclosure herein is intended to cover obvious variants and synonyms even if such variants and synonyms are not explicitly listed.

The technology discussed herein makes reference to servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein may be implemented using a single device or component or multiple devices or components working in combination. Databases and applications may be implemented on a single system or distributed across multiple systems. Distributed components may operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, may readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment may be used with another embodiment to yield a still further embodiment. Thus, it is intended that the present disclosure cover such alterations, variations, and equivalents.

Aspects of the disclosure have been described in terms of illustrative implementations thereof. Numerous other implementations, modifications, or variations within the scope and spirit of the appended claims may occur to persons of ordinary skill in the art from a review of this disclosure. Any and all features in the following claims may be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. The term “or” and “and/or” may be used interchangeably herein. Lists joined by a particular conjunction such as “or,” for example, may refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein may be adapted, rearranged, expanded, omitted, combined, or modified in various ways without deviating from the scope of the present disclosure. At times, elements may be listed in the specification or claims using a letter reference for exemplary illustrated purposes and is not meant to be limiting. Letter references, if used, do not imply a particular order of operations or a particular importance of the listed elements. For instance, letter identifiers such as (a), (b), (c), . . . , (i), (ii), (iii), . . . , etc. may be used to illustrate operations or different elements in a list. Such identifiers are provided for the ease of the reader and do not denote a particular order, importance, or priority of steps, operations, or elements. For instance, an operation illustrated by a list identifier of (a), (i), etc. may be performed before, after, or in parallel with another operation illustrated by a list identifier of (b), (ii), etc.

What is claimed is:

1. A computing system for a vehicle, the computing system comprising:
one or more processors; and
one or more tangible, non-transitory, computer readable media storing instructions for execution by the one or more processors to cause the computing system to perform operations comprising:
accessing a first voice prompt indicative of a speech-based voice query provided by a user of the vehicle;
determining, based on the first voice prompt, a first prompt message corresponding to a text-based transcription of the first voice prompt;
processing the first prompt message with a machine-learned large language model trained to generate a digital message response based on the first prompt message;
converting the digital message response to a speech-based voice response; and
providing the speech-based voice response as audio output to the user of the vehicle.

2. The computing system for a vehicle of claim 1, the operations further comprising:
converting the digital message response to a graphical response; and
providing the graphical response as visual output to the user of the vehicle in conjunction with providing the speech-based voice response as audio output to the user of the vehicle.

3. The computing system for a vehicle of claim 1, wherein:
the speech-based voice query provided by a user of the vehicle comprises a request for information associated with a point of interest category in a particular geographic area; and
the speech-based voice response is indicative of a plurality of particular points of interest determined by the machine-learned large language model to be associated with the point of interest category and the particular geographic area.

4. The computing system for a vehicle of claim 1, the operations further comprising:
receiving user selection data indicative of a selected point of interest from the plurality of particular points of interest; and
generating vehicle navigation data as an output to the user of the vehicle, the vehicle navigation data indicative of navigational directions to the selected point of interest.

5. The computing system for a vehicle of claim 1, the operations further comprising:
comparing a first address associated with the selected point of interest as determined by the machine-learned large language model with a second address associated with the selected point of interest determined from a vehicle navigation database to determine a more recently updated address associated with the selected point of interest; and
providing vehicle navigation data associated with the more recently updated address associated with the selected point of interest as the output to the user of the vehicle.

6. The computing system for a vehicle of claim 1, the operations further comprising:
determining a type of the first prompt message as one of a first type for processing by a vehicle system onboard the vehicle or a second type for processing by the machine-learned large language model; and
processing the first prompt message with the machine-learned large language model in response to determining the first prompt message to be the second type for processing by the machine-learned large language model.

7. The computing system for a vehicle of claim 1, the operations further comprising:
performing a validation function to the digital message response before providing the speech-based voice response as audio output to the user of the vehicle.

8. The computing system for a vehicle of claim 1, wherein determining the first prompt message corresponding to a text-based transcription of the first voice prompt is implemented by a prompt processing system having been trained using terminology from a user guide specific to the vehicle.

9. The computing system for a vehicle of claim 1, wherein the first prompt message corresponds to one or more of a full transcription, a partial transcription, or a modified transcription of the first voice prompt.

10. The computing system for a vehicle of claim 1, wherein the machine-learned large language model comprises a generative pre-trained transformer model.

11. A computer-implemented method, comprising:
accessing a first voice prompt indicative of a speech-based voice query provided by a user of a vehicle;
determining, based on the first voice prompt, a first prompt message corresponding to a text-based transcription of the first voice prompt;
processing the first prompt message with a machine-learned large language model trained to generate a digital message response based on the first prompt message;
converting the digital message response to a speech-based voice response; and
providing the speech-based voice response as audio output to the user of the vehicle.

12. The computer-implemented method of claim 11, further comprising:
converting the digital message response to a graphical response; and
providing the graphical response as visual output to the user of the vehicle in conjunction with providing the speech-based voice response as audio output to the user of the vehicle.

13. The computer-implemented method of claim 11, wherein:
the speech-based voice query provided by a user of the vehicle comprises a request for information associated with a point of interest category in a particular geographic area; and
the speech-based voice response is indicative of a plurality of particular points of interest determined by the machine-learned large language model to be associated with the point of interest category and the particular geographic area.

14. The computer-implemented method of claim 11, further comprising:
receiving user selection data indicative of a selected point of interest from the plurality of particular points of interest; and
generating vehicle navigation data as an output to the user of the vehicle, the vehicle navigation data indicative of navigational directions to the selected point of interest.

15. The computer-implemented method of claim 11, further comprising:
comparing a first address associated with the selected point of interest as determined by the machine-learned large language model with a second address associated with the selected point of interest determined from a vehicle navigation database to determine a more recently updated address associated with the selected point of interest; and
providing vehicle navigation data associated with the more recently updated address associated with the selected point of interest as the output to the user of the vehicle.

16. The computer-implemented method of claim 11, further comprising:
determining a type of the first prompt message as one of a first type for processing by a vehicle system onboard the vehicle or a second type for processing by the machine-learned large language model; and
processing the first prompt message with the machine-learned large language model in response to determining the first prompt message to be the second type for processing by the machine-learned large language model.

17. The computer-implemented method of claim 11, further comprising:
performing a validation function to the digital message response before providing the speech-based voice response as audio output to the user of the vehicle.

18. The computer-implemented method of claim 11, wherein determining the first prompt message corresponding to a text-based transcription of the first voice prompt is implemented by a prompt processing system having been trained using terminology from a user guide specific to the vehicle.

19. One or more tangible, non-transitory, computer readable media storing instructions for execution by one or more processors to cause the one or more processors to perform operations comprising:
accessing a first voice prompt indicative of a speech-based voice query provided by a user of a vehicle;
determining, based on the first voice prompt, a first prompt message corresponding to a text-based transcription of the first voice prompt;
processing the first prompt message with a machine-learned large language model trained to generate a digital message response based on the first prompt message;
converting the digital message response to a speech-based voice response; and
providing the speech-based voice response as audio output to the user of the vehicle.

20. The one or more tangible, non-transitory, computer readable media of claim 19, the operations further comprising:
performing a validation function to the digital message response before providing the speech-based voice response as audio output to the user of the vehicle.
